(19) United States
(12) Patent Application Publication
(10) Pub. No.: US 2013/0295399 A1
(43) Pub. Date: Nov. 7, 2013

(54) BIOCOMPOSITE PANEL

(71) Applicants: Donald Schaefer, Ansbach (DE); Lutz Reitzel, Gross-Zimmern (DE)

(72) Inventors: Donald Schaefer, Ansbach (DE); Lutz Reitzel, Gross-Zimmern (DE)

(21) Appl. No.: 13/825,878

(22) PCT Filed: Oct. 4, 2011
(86) PCT No.: PCT/EP2011/004921

§ 371 Date: Mar. 25, 2013

(30) Foreign Application Priority Data
Oct. 1, 2010 (EP) 10012677.0

(51) Int. Cl. B32B 5/28

(52) U.S. Cl. CPC B32B 5/28
USPC 428/525; 156/60; 156/307.3

(57) ABSTRACT

A biocomposite panel comprising a) at least one natural fiber and b) at least one thermosetting biopolymer, wherein the biocomposite panel has a residual moisture content, based on the total weight thereof, of less than 8.0 wt %, the biocomposite panel comprises at least two sheets of paper, the biopolymer includes a furan resin, and the weight proportion of the biopolymer, based on the total weight of the biocomposite panel, is at least 20.0 wt %.

The present invention relates to a biocomposite plate, processes for production thereof and the use thereof.

Biocomposites, or biocomposite materials of construction, are composite materials of construction with a biogenic component, i.e., a component obtained other than by chemical methods of synthesis. Three versions are more particularly contemplated in this connection:

composites formed from natural fibers and traditional polymers and other matrix materials,

composites formed from synthetic fibers and biopolymers, and

composites formed from natural fibers and biopolymers, which are of particular interest in the context of the present invention, since from ecological viewpoints their production is the most resource sparing.

Biocomposites have been used for centuries in the form of straw-reinforced bricks of clay for example. Since the end of the 20th century they have also been increasingly used for industrial applications. Particularly natural fiber composite materials of construction and wood plastic composites are used here to exploit the advantages of natural fibers over traditional reinforcing and filler materials. These are, in addition to their sustainability and the associated independence from fossil fuels, their CO₂ neutrality, but also their physical properties, such as their low density, their high strength and their stiffness.

In addition to petroleum-based polymers, for example polypropylene and polyethylene or else epoxy resins, biopolymers have increasingly also been used as a matrix material in recent years. Polylactide (polylactic acid, PLA), which is based on maize starch, must be mentioned in particular, but starch or resins produced from palm oil are also used. These materials of construction have some further advantages over petroleum-based polymers with natural fiber reinforcement. They are generally fully biodegradable and their production costs other than the energy requirements of the production operation are independent of the oil price. They also have a distinctly better CO₂ balance.

However, their mechanical properties, especially their strength and their stiffness, their heat resistance, their long term stability and also their sustained use utility, are insufficient for many applications. Especially polylactic acid has a very low heat resistance, possesses a very low Vicat softening temperature of about 70° C. to 75° C., otherwise softens markedly at temperatures as low as around 60° C., and permits only extremely low sustained use temperatures.

In addition, like many other thermoplastic polymers, polylactic acid displays adverse behavior in the event of a fire in that it forms burning drips, which is disadvantageous from a safety point of view.

In light of the prior art, the present invention accordingly has for its object to devise ways to solve the disadvantages of the prior art which are discussed in this application. More particularly, ways to improve the mechanical properties, particularly the strength, the stiffness, the heat resistance, the long term stability and the sustained use utility of conventional composites and biocomposites are to be provided. Biocomposites having a better heat resistance, a better softening behavior and higher sustained use temperatures are further sought. A better behavior in the event of a fire, ideally without burning drips, is also desired. Apart from that, a very good weathering resistance and thermal stability are to be provided.

What are sought in this connection are ideally environmentally compatible solutions, not only with regard to the raw material basis from regenerative sources, but also with regard to the energy and the CO₂ balance which are required to realize the solution. What is particularly important in this connection is especially the desire for a solution which is ideally unconcerning as regards health and the environment and is ideally achievable without the use of halogen-containing, sulfur-containing and/or nitrogen-containing substances in order that the formation of halogen compounds, sulfur oxides and/or nitrogen oxides may ideally be avoided in the incineration of the biocomposites.

The invention shall lastly be actualizable in a very simple manner and very efficiently and cost effectively.

We have found that this object and also further objects which are immediately apparent from the relationships discussed in this application are solved by a composite plate having all the features of the present claim 1. The dependent claims to claim 1 describe particularly advantageous embodiments of the biocomposite plate of the present invention. Protection is additionally sought for preferred processes for producing the biocomposite plate of the present invention and also for particularly advantageous fields of use for the biocomposite plate of the present invention.

By providing a biocomposite plate comprising

a) at least one natural fiber and

b) at least one thermoset biopolymer,

wherein

the biocomposite plate has a residual moisture content, based on its overall weight, below 8.0 wt %,

the biocomposite plate comprises at least two sheets of paper,

the biopolymer includes a furan resin which is obtainable by polymerizing a composition containing a compound of formula (I) and/or formula (II)

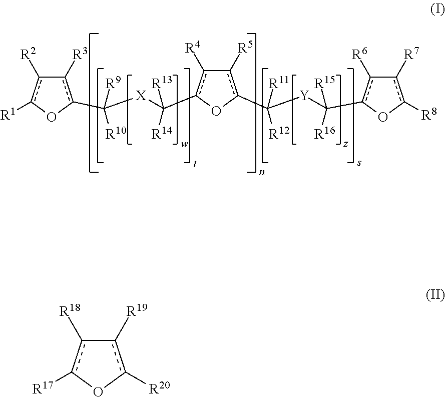

where
n is an integer between 0 and 20, preferably between 0 and 10, especially between 0 and 5,
t and s are each independently an integer between 1 and 20, preferably 1 and 10, especially between 1 and 5,
w and z are each independently 0 or 1,
X and Y are each independently O, S or N—R²¹,
R¹, R², R³, R⁴, R⁵, R⁶, R⁷, R⁸, R⁹, R¹⁰, R¹¹, R¹², R¹³, R¹⁴, R¹⁵, R¹⁶, R¹⁸, R¹⁹ and R²¹ are each independently hydrogen, C₁-C₂₀-alkyl, C₂-C₂₀-alkenyl, C₂-C₂₀-alkynyl, C₅-C₂₄-aryl, C₅-C₁₂-heteroaryl, carboxyaldehyde, hydroxyl, hydroxyalkyl, carboxyl, amino, nitro, formyl, alkylamino, aminoalkyl, alkylaminoalkyl, furyl, furylalkyl, hydroxyalkylfurylalkyl, alkyloxy, alkyloxyalkyl, alkenyloxy, alkylcarbonylalkenyl, oxiranyl, alkylcarbonaloxyalkyl, alkyloxycarbonylalkenyl, alkenylcarbonyloxyalkyl, isocyanate, isocyanatoalkyl, alkylcarboxy, alkenylcarboxy, alkylcarbonyl, alkenylcarbonyl, halocarbonyl, haloalkyl, haloaryl, haloalkenyl, imino, thiol, alkylthio, thioalkyl, alkylthioalkyl, cyano, alkylsulfonyl and/or a sulfonic acid group, wherein every group can be substituted with C₁-C₂₀-alkyl, C₂-C₂₀-alkenyl, C₂-C₂₀-alkynyl, C₅-C₂₄-aryl, hydroxyl, carboxyl, nitro, amino, furyl, furylalkyl, alkylfuryl, hydroxyalkylfurylalkyl, isocyanate, formyl, halocarbonyl, thiol and/or alkylthio,
R¹⁷ is hydrogen, C₁-C₂₀-alkyl, C₂-C₂₀-alkenyl, C₂-C₂₀alkynyl, C₅-C₂₄-aryl, C₅-C₁₂-heteroaryl, carboxyaldehyde, hydroxyl, hydroxyalkyl, carboxyl, amino, nitro, formyl, alkylamino, aminoalkyl, alkylaminoalkyl, furyl, furylalkyl, hydroxyalkylfurylalkyl, alkyloxy, alkyloxyalkyl, alkenyloxy, alkylcarbonylalkenyl, oxiranyl, alkylcarbonyloxyalkyl, alkyloxycarbonylalkenyl, alkenylcarbonyloxyalkyl, isocyanate, isocyanatoalkyl, alkylcarboxy, alkenylcarboxy, alkylcarbonyl, alkenylcarbonyl, halocarbonyl, haloalkyl, haloaryl, haloalkenyl, imino, thiol, alkylthio, thioalkyl, alkylthioalkyl, cyano, alkylsulfonyl and/or a sulfonic acid group, wherein every group can be substituted with C₁-C₂₀-alkyl, C₂-C₂₀-alkenyl, C₂-C₂₀-alkynyl, C₅-C₂₄-aryl, hydroxyl, carboxyl, nitro, amino, furyl, furylalkyl, alkylfuryl, hydroxyalkylfurylalkyl, isocyanate, formyl, halocarbonyl, thiol and/or alkylthio,
R²⁰ is C₁-C₂₀-alkyl, C₂-C₂₀-alkenyl, C₂-C₂₀-alkynyl, C₅-C₂₄-aryl, C₅-C₁₂-heteroaryl, carboxyaldehyde, hydroxyl, hydroxyalkyl, carboxyl, amino, nitro, formyl, alkylamino, aminoalkyl, alkylaminoalkyl, furyl, furylalkyl, hydroxyalkylfurylalkyl, alkyloxy, alkyloxyalkyl, alkenyloxy, alkylcarbonylalkenyl, oxiranyl, alkylcarbonyloxyalkyl, alkyloxycarbonylalkenyl, alkenylcarbonyloxyalkyl, isocyanate, isocyanatoalkyl, alkylcarboxy, alkenylcarboxy, alkylcarbonyl, alkenylcarbonyl, halocarbonyl, haloalkyl, haloaryl, haloalkenyl, imino, thiol, alkylthio, thioalkyl, alkylthioalkyl, cyano, alkylsulfonyl and/or a sulfonic acid group, wherein every group can be substituted with C₁-C₂₀-alkyl, C₂-C₂₀-alkenyl, C₂-C₂₀-alkynyl, C₅-C₂₄-aryl, hydroxyl, carboxyl, nitro, amino, furyl, furylalkyl, alkylfuryl, hydroxyalkylfurylalkyl, isocyanate, formyl, halocarbonyl, thiol and/or alkylthio, and

wherein the broken line depicts an optional double bond, and

the weight fraction of the biopolymer, based on the overall weight of the biocomposite plate, is not less than 20.0 wt %,

the present invention provides a totally unforeseeable way to solve the disadvantages of the prior art which are discussed in this application. More particularly, a way to improve the mechanical properties, especially the strength, the stiffness, the heat resistance, the long term stability and the sustained use utility of conventional biocomposites and composite materials of construction is specified. The biocomposite plate of the present invention additionally evinces better heat resistance, shows a distinctly better softening behavior and permits higher sustained use temperatures. Its behavior in the event of a fire is further significantly better, especially without burning drips. The biocomposite plate of the present invention is lastly also suitable for a very good weathering resistance and thermal stability.

The solution provided by the present invention is extremely environment-friendly, not only with regard to the raw material basis from regenerative sources, but also with regard to the energy and CO₂ balance which are needed to produce the biocomposite plate of the present invention. Its production costs other than the energy requirements of the production operation are independent of the oil price. The biocomposite plate of the present invention further has a distinctly improved CO₂ balance.

What is particularly important in this connection is particularly that the biocomposite plate of the present invention is extremely unconcerning from a health and environmental point of view. The biocomposite plate of the present invention comprises comparatively small amounts of halogen-containing, sulfur-containing and/or nitrogen-containing substances, so the formation of halogen compounds, sulfur oxides and/or nitrogen oxides in the incineration of the biocomposite plate of the present invention is comparatively low.

The invention can lastly be actualized in a comparatively simple manner, extremely efficiently and cost effectively.

The biocomposite plate of the present invention comprises at least one natural fiber. A natural fiber is any fiber that comes from natural sources, such as plants, animals or minerals, and can be used directly, without further chemical transforming reactions. Preference in this connection is given to vegetable fibers and animal fibers, especially vegetable fibers.

The natural fibers of the present invention must accordingly be delimited from manufactured fibers.

Vegetable fibers suitable for the purposes of the present invention can be of disparate origin and accordingly have disparate properties. They include more particularly vegetable fibers which occur as vascular bundles in the stalk or stem or pseudostem, of the cortex, especially as bast fiber, or as seed outgrowths. They further include wood fibers, which are very particularly suitable in the context of the present invention.

Preferred vegetable fibers include seed fibers, especially cotton (CO) from the seed hairs of the fruit of the cotton plant, kapok (KP) from the interior of the capsular fruit of the true kapok tree, poplar wool and Calotropis silk; bast fibers, especially bamboo fibers, stinging nettle, hemp fibers (HA), jute (JU), kenaf, linen (LI) from common flax, hops, ramie (RA) and Sunn hemp; leaf fibers, especially abaca (manilla hemp), hard fibers from leaves of a fiber banana, pineapple, caroa, curaua, henequen, macambira, New Zealand flax and sisal (SI) from agave leaves; and also fruit fibers, especially coir (CC) from the husk of coconuts.

Leaf fibers and the coir fiber are occasionally also referred to as hard fibers.

In addition to the sisal agave, there are a whole series of further fiber-yielding species from the family of agaves, which belong inter alia to the genus Furcraea. These are also referred to as Mauritius hemp and can likewise be used with advantage for the present invention.

In addition, the use of various rushes, especially from split bamboo and from other plants, as fiber material is also particularly advantageous.

Preferred natural fibers of animal origin include those fibers which form the hair follicles in the case of animals, especially the fibers which are present in the form of a hair covering or a fur. In addition there are silk fibers from the cocoon of pupated silk worms, and also other fibers formed from secretions, such as spiders' silk or the Byssus fibers.

Particularly suitable natural fibers of animal origin include wool and fine animal hairs, especially wool from sheep (WO; occasionally known as virgin wool), alpaca, llama, vikunja, guanako, angora (WA), rabbit, camel hair (WK), cashmere (WS) and mohair (WM); coarse animal hairs, especially cattle hair, particularly the hair from the yak, horse hair and goat hair; and also silk, especially mulberry silk (SE), Tussah silk (ST) and mollusc silk.

The abbreviations between parentheses indicate in this connection the current codes to DIN 60001-1.

The mineral fibers which are preferred according to the present invention include attapulgite, sepiolite and wollastonite.

Preferred wood fibers include mechanical pulp and chemical pulp.

Mechanical pulp is preferably obtained from the raw material wood, which consists mainly of lignocellulose. Lignocellulose in turn consists of cellulose molecules bundled together to form fibers. A matrix of lignin pervades the cellulose to form a compression- and tension-resistant composite.

The production of mechanical pulp involves the wood being defiberized, especially by the ground process, the groundwood process, the pressure groundwood process, the refiner process, the thermo mechanical pulp (TMP) process or the chemo thermo mechanical pulp (CTMP) process.

In the production of chemical pulp, by contrast, the lignin fraction is removed using chemical methods, especially the alkaline sulfate process or the acidic sulfite process to obtain, with a lower yield and higher cost and inconvenience, the more highly prized chemical pulp which consists almost completely of cellulose. Logwood or polewood is usually used, while hardwood is preferred on account of its being long-fibered.

Cellulose fibers are very particularly suitable for the purposes of the present invention. Accordingly, the proportion of the overall weight of the natural fibers which is contributed by cellulose fibers is preferably above 50.0 wt %, advantageously above 60.0 wt %, more preferably above 70.0 wt %, even more preferably above 80.0 wt %, yet even more preferably above 90.0 wt % and especially above 95.0 wt %. Cellulose fibers are used exclusively in a very particularly preferred embodiment of the present invention.

In the context of the present invention, the biocomposite plate comprises two or more sheets of paper which preferably combine to form a paper composite which hereinafter will occasionally also be referred to as core layer.

Paper is defined in DIN 6730 (1996-05) as a sheetlike material of construction which consists essentially of fibers of predominantly vegetable origin and which is formed by dewatering a fibrous slurry on a wire screen. This produces a fibrous felt which is subsequently compacted and dried.

For the purposes of the present invention, the paper preferably comprises not less than 50.0 wt %, more preferably not less than 60.0 wt %, even more preferably not less than 70.0 wt %, even yet more preferably not less than 80.0 wt %, yet still even more preferably not less than 90.0 wt % and especially from 91.0 to 95.0 wt % of natural fibers, especially cellulose fibers. The proportion of fillers, especially kaolin and/or calcium carbonate, is preferably below 20.0 wt %, more preferably below 15.0 wt %, even more preferably below 10.0 wt % and is advantageously in the range from 6.0 wt % to 9.0 wt %. These particulars each relate to the overall weight of the paper and preferably sum to 100.0 wt %.

In the context of a particularly preferred embodiment of the present invention, the paper is recycled paper, which preferably consists predominantly of reused wastepaper and therefore is particularly environment-friendly. This, in addition to minimizing the use of wood resources, is advantageous because energy and water requirements are reduced by two-thirds compared with conventional papermaking.

The quality and tensile strength of paper can be increased by admixing virgin fibers, although the proportion of recycled paper is preferably not less than 80.0 wt %, based on the overall paper weight.

In the context of a particularly preferred embodiment of the present invention, unbleached wastepaper is used as recycled paper.

Paper recycling preferably proceeds by the following process:

First, the paper is split into individual paper fibers with water, producing a thin pulp; this stage is usually referred to as resuspension.

Next, the aqueous pulp is subjected to a cleaning operation to remove nonfibrous, foreign bodies. This step frequently also includes a wash with chemical cleaning agents.

The fibers are preferably not decolorized, especially not with sodium hydroxide or sodium carbonate. The same holds for bleaching, for example with peroxides or hydrosulfites, to remove colored particles from the paper pulp. This is preferably likewise not carried out.

Lastly, the ready-produced fibrous stuff is used to manufacture a “new” paper-based article, preferably by mixing with primary fibers from trees in different proportions or simply by the direct production of recycled paper.

The actual process of sheet formation is then typically the same as with virgin-fiber paper:

First, the paper pulp mixture is further diluted with water to produce a very thin pulp. This thin mass is then drained off on a finely meshed wire screen section to form a fibrous tissue.

This moving web of fibrous tissue is pressed into a continuous sheet of paper and dried.

During the modelling operation, it is preferable to apply a certain amount of paper pulp, advantageously in a continuous manner, to at least one wire screen, so the fibers form a sheet on the wire screen and excess water can drain away. The paper can then be removed and start to dry. After drying, this continuous fibrous tissue can be wound up on rolls.

For further details, reference is made to the technical literature, especially to Römpp-Lexikon Chemie; editors: Jürgen Falbe, Manfred Regitz; revised by Eckard Amelingmeier; Stuttgart, N.Y.; Thieme; 10th edition; volume 1 A-CI (1996), headword “Altpapier” [Wastepaper] and volume 4 M-Pk (1998), headword “Papier” [Paper] and also the references cited there.

The use of kraft paper is particularly advantageous in the context of the present invention. Kraft paper is defined by DIN 6730 to be a paper which consists predominantly of kraft-process chemical-pulp stuff (which may incorporate added kraft-process chemical-pulp paper) and which has high strength, in particular high tensile strength, and high stability. Kraft paper is typically produced from fresh, preferably unbleached, sulfate pulp (kraft-process chemical-pulp stuff) at 90% at least. Kraft paper in addition to the chemical-pulp stuff may further contain starch, alum and/or size in order that certain surface effects and strength enhancements may be achieved for example. Soda kraft paper, which is familiar to a person skilled in the art of composite materials of construction, is a preferred kraft paper.

The number of paper sheets used depends essentially on the thickness desired for the biocomposite plate. The number of paper sheets the biocomposite plate contains is preferably in the range from two to 200 sheets, preferably from three to 150 sheets and especially from four to 100 sheets of paper, in particular recycled paper.

The weight of the paper used for the purposes of the present invention is not further restricted. It depends in particular on the number of sheets of paper used and thus on the thickness desired for the biocomposite plate. In one preferred embodiment, the weight of the paper sheets used is in the range from 125 g/m² to 250 g/m² and preferably in the range from 140 g/m² to 230 g/m².

In one preferred embodiment, the final thickness of the biocomposite plate according to the present invention is in the range from 0.75 mm to 0.85 mm, preferably equal to 0.8 mm. It may be preferable in this case to use four sheets of paper which have a weight of 125 g/m² to 175 g/m², preferably 150 g/m². On the other hand, it is also possible to use three sheets of paper for this, which have a weight in the range from 200 g/m² to 240 g/m², preferably in the range from 210 g/m² to 230 g/m².

In a further preferred embodiment, the final thickness of the biocomposite plate according to the present invention is in the range from 0.95 mm to 1.05 mm, preferably equal to 1.0 mm. It may be preferable in this case to use five sheets of paper, which have a weight of 125 g/m² to 175 g/m², preferably 150 g/m². On the other hand, it is also possible to use four sheets of paper for this, which have a weight of from 200 g/m² to 240 g/m², preferably in the range from 210 g/m² to 230 g/m².

In yet a further preferred embodiment, the final thickness of the biocomposite plate according to the present invention is in the range from 1.15 mm to 1.25 mm, preferably equal to 1.2 mm. It may be preferable in this case to use six sheets of paper which have a weight of 125 g/m² to 175 g/m², preferably 150 g/m². On the other hand, five sheets of paper can also be used for this, which have a weight in the range from 200 g/m² to 240 g/m², preferably in the range from 210 g/m² to 230 g/m².

In yet a further preferred embodiment, the final thickness of the biocomposite plate according to the present invention is above 1.0 mm, preferably above 1.25 mm, more preferably above 1.5 mm, even more preferably not less than 2.0 mm and is preferably in the range from 2.0 mm to 40.0 mm, more preferably in the range from 2.0 mm to 30.0 mm and even more preferably in the range from 2.0 mm to 20.0 mm. This plate is preferably produced using sheets of paper which have a weight in the range from 125 g/m² to 250 g/m², preferably in the range from 140 g/m² to 230 g/m².

One surface of the paper composite (core layer) has applied to it a decor layer in the context of a particularly preferred embodiment of the present invention. This decor layer preferably endows the biocomposite plate of the present invention with its appearance. Accordingly, the decor layer is that layer on the paper composite whose pattern is visually perceivable by the observer.

Particularly suitable decor layers for the purposes of the present invention include decor papers, textiles, wovens, stuffs and wallpapers, while materials comprising natural fiber are very particularly preferred in this connection.

As used herein, decor paper refers to any material which is suitable for bonding to the core layer underneath and is able to reproduce a decor. Paper, especially recycled paper, is the preferred material for the decor paper.

The decor is typically applied to the decor paper via a printing operation. For instance a desired motif can be established via phototechnical reproduction and be applied to the decor paper by gravure printing. The motif can consist of wood, stone, ceramic, colored and/or fancy patterns for example. But the motif can also be effected by brushing the decor paper with one or more inks.

The basis weight of the decor paper used is not further restricted. The basis weight is preferably in the range from 40 g/m² to 120 g/m², more preferably in the range from 60 g/m² to 100 g/m² and especially in the range from 70 g/m² to 90 g/m². This holds for printed decors in particular.

Textiles for the purposes of the present invention are flexible materials which consist of an assembly of fibers. Not only fibers but also yarns and textile fabrics, such as wovens, formed-loop knits or drawn-loop knits, are also subsumed under the generic term textiles. German standard specification DIN 60000 is referenced for further details.

Wovens is the generic term for articles of manual or machine manufacture in weaving, such as cloth, velvet, velour, plush, terry or other textile fabrics consisting of two or more systems of threads crossing at right angles or substantially right angles.

The threads in the longitudinal direction are known as warp threads, or the warp. The transverse threads are weft threads, or the weft. The threads are joined together by the threads crossing. The threads crossing is not to be understood as meaning that the threads lie on top of each other in a crossing manner, but that threads pass over and under the transverse threads in a certain rhythm (known as the repeat). In order that a woven fabric is sufficiently resistant to thread slippage, the weft and warp threads are preferably combined in a relatively close weave.

Wallpapers are continuous sheets of cellulose, glass fabric or plastic, or even in rare cases of gold skin, leather or canvas, which can be glued to the wall with a suitable adhesive. Particularly preferred wallpapers for the purposes of the present invention comprise natural fibers, especially cellulose.

Further layers can optionally be disposed between the core layer and the decor layer, for example an underlay layer. This underlay layer can have the purpose for example of preventing warpage of the biocomposite plate and/or reducing electrostatic charges. The underlay layer preferably comprises one or more sheets of recycled paper.

In the context of the present invention, the biocomposite plate further comprises at least one biopolymer which acts as a binder in binding the various sheets of paper together. When there is a decor layer and/or an underlay layer in addition to the core layer, then the binder binding any underlay sheets to each other, the core layer to any underlay layer and any underlay layer to any decor layer, preferably likewise comprises at least one biopolymer.

A person skilled in the art will appreciate here that the interfaces between individual layers, for example the interface between the core layer and the decor layer, are where the binders used can become mixed in particular and that the boundaries between the individual layers are usually not defined by the binder used but in particular by the outermost sheets forming the individual layers.

Biopolymers in the context of the present invention are polymers produced from renewable raw materials to a predominant extent, preferably to an extent of more than 50.0 wt %, more preferably to an extent of more than 75.0 wt %, even more preferably to an extent of more than 90.0 wt %, yet even more preferably to an extent of more than 95.0 wt % and especially to an extent of 100.0 wt %. Biopolymers can be biodegradable polymers or durable polymers, and it is the latter which are particularly preferred according to the invention.

For the purposes of the present invention, the biopolymer is present as a thermoset in the cured state.

Thermosets are plastics which after curing are not formable at the use temperature, preferably at temperatures in the range from 0° C. to 100° C., especially at 25° C. Thermosets are hard, vitreous polymeric materials of construction which are thermally crosslinked three-dimensionally via chemical main-valency bonds. The crosslinking takes place on mixing precursors having branching sites and is activated either chemically (isothermally) at room temperature by means of catalysts or thermally (exothermically) at high temperatures.

In the context of the present invention, the biopolymer includes at least one furan resin, preferably a polymer having optionally substituted furan rings in its main chain. This furan resin is obtainable by polymerizing a composition containing a compound of formula (I) and/or formula (II)

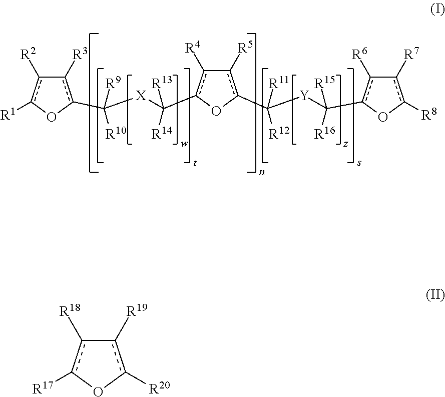

where
n is an integer between 0 and 20, preferably between 0 and 10, especially between 0 and 5,
t and s are each independently an integer between 1 and 20, preferably 1 and 10, especially between 1 and 5,
w and z are each independently 0 or 1,
X and Y are each independently O, S or N—R²¹,
R¹, R², R³, R⁴, R⁵, R⁶, R⁷, R⁸, R⁹, R¹⁰, R¹¹, R¹², R¹³, R¹⁴, R¹⁵, R¹⁶, R¹⁸, R¹⁹ and R²¹ are each independently hydrogen, C₁-C₂₀-alkyl, C₂-C₂₀-alkenyl, C₂-C₂₀-alkynyl, C₅-C₂₄-aryl, C₅-C₁₂-heteroaryl, carboxyaldehyde, hydroxyl, hydroxyalkyl, carboxyl, amino, nitro, formyl, alkylamino, aminoalkyl, alkylaminoalkyl, furyl, furylalkyl, hydroxyalkylfurylalkyl, alkyloxy, alkyloxyalkyl, alkenyloxy, alkylcarbonylalkenyl, oxiranyl, alkylcarbonaloxyalkyl, alkyloxycarbonylalkenyl, alkenylcarbonyloxyalkyl, isocyanate, isocyanatoalkyl, alkylcarboxy, alkenylcarboxy, alkyl carbonyl, alkenylcarbonyl, halocarbonyl, haloalkyl, haloaryl, haloalkenyl, imino, thiol, alkylthio, thioalkyl, alkylthioalkyl, cyano, alkylsulfonyl and/or a sulfonic acid group, wherein every group can be substituted with C₁-C₂₀-alkyl, C₂-C₂₀-alkenyl, C₂-C₂₀-alkynyl, C₅-C₂₄-aryl, hydroxyl, carboxyl, nitro, amino, furyl, furylalkyl, alkylfuryl, hydroxyalkylfurylalkyl, isocyanate, formyl, halocarbonyl, thiol and/or alkylthio,
R¹⁷ is hydrogen, C₁-C₂₀-alkyl, C₂-C₂₀-alkenyl, C₂-C₂₀-alkynyl, C₅-C₂₄-aryl, C₅-C₁₂-heteroaryl, carboxyaldehyde, hydroxyl, hydroxyalkyl, carboxyl, amino, nitro, formyl, alkylamino, aminoalkyl, alkylaminoalkyl, furyl, furylalkyl, hydroxyalkylfurylalkyl, alkyloxy, alkyloxyalkyl, alkenyloxy, alkylcarbonylalkenyl, oxiranyl, alkylcarbonyloxyalkyl, alkyloxycarbonylalkenyl, alkenylcarbonyloxyalkyl, isocyanate, isocyanatoalkyl, alkylcarboxy, alkenylcarboxy, alkylcarbonyl, alkenylcarbonyl, halocarbonyl, haloalkyl, haloaryl, haloalkenyl, imino, thiol, alkylthio, thioalkyl, alkylthioalkyl, cyano, alkylsulfonyl and/or a sulfonic acid group, wherein every group can be substituted with C₁-C₂₀-alkyl, C₂-C₂₀-alkenyl, C₂-C₂₀-alkynyl, C₅-C₂₄-aryl, hydroxyl, carboxyl, nitro, amino, furyl, furylalkyl, alkylfuryl, hydroxyalkylfurylalkyl, isocyanate, formyl, halocarbonyl, thiol and/or alkylthio,
R²⁰ is C₁-C₂₀-alkyl, C₂-C₂₀-alkenyl, C₂-C₂₀-alkynyl, C₅-C₂₄-aryl, C₅-C₁₂-heteroaryl, carboxyaldehyde, hydroxyl, hydroxyalkyl, carboxyl, amino, nitro, formyl, alkylamino, aminoalkyl, alkylaminoalkyl, furyl, furylalkyl, hydroxyalkylfurylalkyl, alkyloxy, alkyloxyalkyl, alkenyloxy, alkylcarbonylalkenyl, oxiranyl, alkylcarbonyloxyalkyl, alkyloxycarbonylalkenyl, alkenylcarbonyloxyalkyl, isocyanate, isocyanatoalkyl, alkylcarboxy, alkenylcarboxy, alkylcarbonyl, alkenylcarbonyl, halocarbonyl, haloalkyl, haloaryl, haloalkenyl, imino, thiol, alkylthio, thioalkyl, alkylthioalkyl, cyano, alkylsulfonyl and/or a sulfonic acid group, wherein every group can be substituted with C₁-C₂₀-alkyl, C₂-C₂₀-alkenyl, C₂-C₂₀-alkynyl, C₅-C₂₄-aryl, hydroxyl, carboxyl, nitro, amino, furyl, furylalkyl, alkylfuryl, hydroxyalkylfurylalkyl, isocyanate, formyl, halocarbonyl, thiol and/or alkylthio, and

wherein the broken line depicts an optional double bond.

In the context of the present invention, the designations used are to be understood as follows.

The designation “alkyl”, as itself or as part of another substituent, represents a straight-chain or branched, saturated hydrocarbonaceous group wherein the carbon atoms are connected to each other via carbon-carbon single bonds and where the number of carbon atoms is preferably from 1 to 20, more preferably from 1 to 10, even more preferably from 1 to 8, indeed even more preferably from 1 to 6 and especially 1, 2, 3 or 4 carbon atoms. When in the context of the present application a subscripted index is used following a carbon atom, the index indicates the number of carbon atoms in said group. For instance, C₁₋₄ alkyl represents an alkyl having 1 to 4 carbon atoms. Examples of preferred alkyl groups include methyl, ethyl, propyl, isopropyl, butyl, isobutyl, sec-butyl, tert-butyl, 2-methylbutyl, pentyl, isoamyl and its isomers, hexyl and its isomers, heptyl and its isomers and octyl and its isomers. When the expression “alkyl” is used together with a further, preceding expression, as in “hydroxyalkyl” for example, this designates an alkyl group as defined above which is substituted with one or two, preferably one, substituent of the concretely recited group as also defined herein. The expression “C₁-C₂₀-alkyl” as used herein represents an alkyl group having 1, 2, 3, 4, 5, 6, 7, 8, 9, 10, 11, 12, 13, 14, 15, 16, 17, 18, 19 or 20 carbon atoms.

The designation “alkenyl”, as itself or as part of another substituent, represents a straight-chain or branched hydrocarbonaceous chain which includes at least one carbon-carbon double bond and which preferably has 2 to 20 carbon atoms, advantageously from 2 to 10 carbon atoms, preferably 2 to 8 carbon atoms, more preferably from 2 to 6 carbon atoms and especially 2, 3 or 4 carbon atoms. Examples of preferred alkenyl groups include ethenyl (vinyl), 2-propenyl, 2-butenyl, 3-butenyl, 2-pentenyl and its isomers, 2-hexenyl and its isomers, 2-heptenyl and its isomers, 2-octenyl and its isomers, 2,4-pentadienyl, etc. The expression “C₂-C₂₀-alkenyl” as used herein represents an alkenyl group having 2, 3, 4, 5, 6, 7, 8, 9, 10, 11, 12, 13, 14, 15, 16, 17, 18, 19 or 20 carbon atoms.

The designation “alkynyl”, as itself or as part of another substituent, represents a straight-chain or branched hydrocarbonaceous chain which includes at least one carbon-carbon triple bond and which preferably has 2 to 20 carbon atoms, advantageously from 2 to 10 carbon atoms, preferably 2 to 8 carbon atoms, more preferably from 2 to 6 carbon atoms and especially 2, 3 or 4 carbon atoms. Examples of preferred alkynyl groups include ethynyl, 2-propynyl, 2-butynyl, 3-butynyl, 2-pentynyl and its isomers, 2-hexynyl and its isomers, 2-heptynyl and its isomers, 2-octynyl and its isomers, etc. The expression “C₂-C₂₀-alkynyl” as used herein represents an alkynyl group having 2, 3, 4, 5, 6, 7, 8, 9, 10, 11, 12, 13, 14, 15, 16, 17, 18, 19 or 20 carbon atoms.

When the alkyl groups are divalent, i.e., when they have two single bonds for attachment to two other groups, they are designated “alkylene” groups.

Examples of preferred alkylene groups include methylene, ethylene, methylmethylene, trimethylene, propylene, tetramethylene, ethylethylene, 1,2-dimethylethylene, pentamethylene and hexamethylene. Correspondingly, alkenyl groups and alkynyl groups, that have two single bonds for attachment to two other groups, are designated “alkenylene” groups and “alkynylene” groups respectively.

The designation “aryl”, as itself or as part of another substituent, represents an aromatic hydrocarbonaceous ring system, especially a monocyclic, bicyclic or tricyclic ring system or a ring system comprising 1 to 4 rings fused together or bonded covalently to each other, wherein the rings preferably each include 5 to 8 carbon atoms and at least one of the rings is aromatic. The aromatic ring may optionally include 1 to 3 further rings, especially cycloalkyl rings, heterocyclic rings or heteroaryl rings which are fused with the ring. In the context of the present invention, the aryl group preferably has 5 to 24 carbon atoms. Examples of preferred aryl groups include phenyl, biphenylyl, biphenylenyl, 5- or 6-tetralinyl, 1-, 2-, 3-, 4-, 5-, 6-, 7- or 8-azulenyl, 1- or 2-naphthyl, 1-, 2- or 3-indenyl, 1-, 2- or 9-anthryl, 1-, 2-, 3-, 4- or 5-acenaphthylenyl, 3-, 4- or 5-acenaphthenyl, 1-, 2-, 3-, 4- or 10-phenanthryl, 1- or 2-pentalenyl, 1-, 2-, 3- or 4-fluorenyl, 4- or 5-indanyl, 5-, 6-, 7- or 8-tetrahydronaphthyl, 1,2,3,4-tetrahydronaphthyl, 1,4-dihydronaphthyl, dibenzo[a,d]cycloheptenyl, 1-, 2-, 3-, 4- or 5-pyrenyl. The expression “C₅-C₂₄-aryl” as used herein represents an aryl group having 5, 6, 7, 8, 9, 10, 11, 12, 13, 14, 15, 16, 17, 18, 19, 20, 21, 22, 23 or 24 carbon atoms.

The designation “heteroaryl”, as itself or as part of another substituent, represents 5 to 12 carbon-comprising aromatic rings or ring systems comprising 1 to 3 rings which are fused together or bonded together covalently and preferably include 5 to 8 atoms. At least one of the rings therein is aromatic, in which case one or more carbon atoms in one or more of these rings can be replaced by oxygen, nitrogen or sulfur atoms, in which case the nitrogen or sulfur heteroatoms can optionally be oxidized and the nitrogen atoms can optionally be quaternized. Rings of this type can be fused with an aryl, cycloalkyl, heteroaryl or heterocyclyl ring.

The designation “hydroxyalkyl” represents a group —R^{b}—OH, where R^{b} is an alkylene as defined above.

The designation “amino” represents an —NH₂ group.

The designation “alkylamino” represents a group —N(R^{e})(R^{f}), where R^{e} and R^{f} are each independently hydrogen or an alkyl group which may each be optionally substituted with C₁-C₂₀-alkyl, C₂-C₂₀-alkenyl, C₂-C₂₀-alkynyl, C₅-C₂₄-aryl, hydroxyl, carboxyl, nitro, amino, furyl, furylalkyl, alkylfuryl, hydroxyalkylfurylalkyl, isocyanate, formyl, halocarbonyl, thiol and/or alkylthio.

The designation “aminoalkyl” represents a group —R^{b}—NH₂, where R^{b} is an alkylene as defined above which may optionally be substituted with C₁-C₂₀-alkyl, C₂-C₂₀-alkenyl, C₂-C₂₀-alkynyl, C₅-C₂₄-aryl, hydroxyl, carboxyl, nitro, amino, furyl, furylalkyl, alkylfuryl, hydroxyalkylfurylalkyl, isocyanate, formyl, halocarbonyl, thiol and/or alkylthio.

The designation “alkylaminoalkyl” represents a group —R^{b}—N(R^{e})(R^{f}), where R^{b} is an alkylene as defined above which may optionally be substituted with C₁-C₂₀-alkyl, C₂-C₂₀-alkenyl, C₂-C₂₀-alkynyl, C₅-C₂₄-aryl, hydroxyl, carboxyl, nitro, amino, furyl, furylalkyl, alkylfuryl, hydroxyalkylfurylalkyl, isocyanate, formyl, halocarbonyl, thiol and/or alkylthio, and where R^{e} and R^{f} are each independently hydrogen or an alkyl group which may each be optionally substituted with C₁-C₂₀-alkyl, C₂-C₂₀-alkenyl, C₂-C₂₀-alkynyl, C₅-C₂₄-aryl, hydroxyl, carboxyl, nitro, amino, furyl, furylalkyl, alkylfuryl, hydroxyalkylfurylalkyl, isocyanate, formyl, halocarbonyl, thiol and/or alkylthio.

The designation “carboxy” corresponds to the designation “hydroxycarbonyl” and represents a group —CO₂H. The designation “alkylcarboxy” corresponds to the designation “alkyloxycarbonyl” and represents a group —CO₂—R^{a}, where R^{a} is an alkyl which may optionally be substituted with C₁-C₂₀-alkyl, C₂-C₂₀-alkenyl, C₂-C₂₀-alkynyl, C₅-C₂₄-aryl, hydroxyl, carboxyl, nitro, amino, furyl, furylalkyl, alkylfuryl, hydroxyalkylfurylalkyl, isocyanate, formyl, halocarbonyl, thiol and/or alkylthio. The designation “alkenylcarboxy” corresponds to the designation “alkenyloxycarbonyl” and represents a group —CO₂—R^{c}, where R^{c} is an alkenyl which may optionally be substituted with C₁-C₂₀-alkyl, C₂-C₂₀-alkenyl, C₂-C₂₀-alkynyl, C₅-C₂₄-aryl, hydroxyl, carboxyl, nitro, amino, furyl, furylalkyl, alkylfuryl, hydroxyalkylfurylalkyl, isocyanate, formyl, halocarbonyl, thiol and/or alkylthio.

The designation “carboxyaldehyde” or “formyl” represents the group C(═O)H.

The designation “furyl” represents a group which can be depicted by the formula (III):

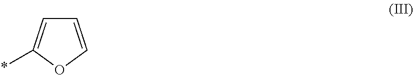 [SMILES: *c1ccco1]

Asterisks (*) are used herein to indicate the position at which the depicted free radical attaches to the structure to which it relates and of which it is part.

The designation “furylalkyl” represents a group —R^{b}-furyl, where furyl is as defined above and R^{b} is an alkylene as defined above which may optionally be substituted with C₁-C₂₀-alkyl, C₂-C₂₀-alkenyl, C₂-C₂₀-alkynyl, C₅-C₂₄-aryl, hydroxyl, carboxyl, nitro, amino, furyl, furylalkyl, alkylfuryl, hydroxyalkylfurylalkyl, isocyanate, formyl, halocarbonyl, thiol and/or alkylthio.

The designation “hydroxyalkylfurylalkyl” represents a group —R^{b}-furyl-R^{b}—OH, where furyl is as defined above and R^{b} is an alkylene as defined above.

The designation “alkylfuryl” represents a group -furyl-R^{b}, where furyl is as defined above and R^{b} is an alkylene as defined above which may optionally be substituted with C₁-C₂₀-alkyl, C₂-C₂₀-alkenyl, C₂-C₂₀-alkynyl, C₅-C₂₄-aryl, hydroxyl, carboxyl, nitro, amino, furyl, furylalkyl, alkylfuryl, hydroxyalkylfurylalkyl, isocyanate, formyl, halocarbonyl, thiol and/or alkylthio.

The designation “alkoxy” or “alkyloxy” represents a group —O—R^{a}, where R^{a} is an alkyl which may optionally be substituted with C₁-C₂₀-alkyl, C₂-C₂₀-alkenyl, C₂-C₂₀-alkynyl, C₅-C₂₄-aryl, hydroxyl, carboxyl, nitro, amino, furyl, furylalkyl, alkylfuryl, hydroxyalkylfurylalkyl, isocyanate, formyl, halocarbonyl, thiol and/or alkylthio.

The designation “alkoxyalkyl” or “alkyloxyalkyl” represents a group —R^{b}—O—R^{a}, where R^{a} is an alkyl which may optionally be substituted with C₁-C₂₀-alkyl, C₂-C₂₀-alkenyl, C₂-C₂₀-alkynyl, C₅-C₂₄-aryl, hydroxyl, carboxyl, nitro, amino, furyl, furylalkyl, alkylfuryl, hydroxyalkylfurylalkyl, isocyanate, formyl, halocarbonyl, thiol and/or alkylthio, and R^{b} is an alkylene as defined above which may optionally be substituted with C₁-C₂₀-alkyl, C₂-C₂₀-alkenyl, C₂-C₂₀-alkynyl, C₅-C₂₄-aryl, hydroxyl, carboxyl, nitro, amino, furyl, furylalkyl, alkylfuryl, hydroxyalkylfurylalkyl, isocyanate, formyl, halocarbonyl, thiol and/or alkylthio.

The designation “alkenyloxy” represents a group —O—R^{b}, where R^{b} is an alkylene as defined above which may optionally be substituted with C₁-C₂₀-alkyl, C₂-C₂₀-alkenyl, C₂-C₂₀-alkynyl, C₅-C₂₄-aryl, hydroxyl, carboxyl, nitro, amino, furyl, furylalkyl, alkylfuryl, hydroxyalkylfurylalkyl, isocyanate, formyl, halocarbonyl, thiol and/or alkylthio. Vinyl ether is an example.

The designation “alkyloxycarbonylalkenyl” represents a group —R^{d}—C(═O)—O—R^{a}, where R^{d} is an alkenylene as defined above which may optionally be substituted with C₁-C₂₀-alkyl, C₂-C₂₀-alkenyl, C₂-C₂₀-alkynyl, C₅-C₂₄-aryl, hydroxyl, carboxyl, nitro, amino, furyl, furylalkyl, alkylfuryl, hydroxyalkylfurylalkyl, isocyanate, formyl, halocarbonyl, thiol and/or alkylthio and where R^{a} is an alkyl which may optionally be substituted with C₁-C₂₀-alkyl, C₂-C₂₀-alkenyl, C₂-C₂₀-alkynyl, C₅-C₂₄-aryl, hydroxyl, carboxyl, nitro, amino, furyl, furylalkyl, alkylfuryl, hydroxyalkylfurylalkyl, isocyanate, formyl, halocarbonyl, thiol and/or alkylthio.

The designation “oxiranyl” represents an epoxy group —C₂H₃O.

The designation “alkylcarbonyl” represents a group —C(═O)R^{a}, where R^{a} is an alkyl which may optionally be substituted with C₁-C₂₀-alkyl, C₂-C₂₀-alkenyl, C₂-C₂₀-alkynyl, C₅-C₂₄-aryl, hydroxyl, carboxyl, nitro, amino, furyl, furylalkyl, alkylfuryl, hydroxyalkylfurylalkyl, isocyanate, formyl, halocarbonyl, thiol and/or alkylthio. Preferred examples include acetyl, propionyl, butyryl, valeryl and pivaloyl.

The designation “alkenylcarbonyl” represents a group —C(═O)R^{c}, where R^{c} is an alkenyl which may optionally be substituted with C₁-C₂₀-alkyl, C₂-C₂₀-alkenyl, C₂-C₂₀-alkynyl, C₅-C₂₄-aryl, hydroxyl, carboxyl, nitro, amino, furyl, furylalkyl, alkylfuryl, hydroxyalkylfurylalkyl, isocyanate, formyl, halocarbonyl, thiol and/or alkylthio. Vinyl ketone is a preferred example.

The designation “alkylcarbonyloxyalkyl” represents a group —R^{b}—O—C(═O) R^{a}, where R^{b} is an alkylene as defined above which may optionally be substituted with C₁-C₂₀-alkyl, C₂-C₂₀-alkenyl, C₂-C₂₀-alkynyl, C₅-C₂₄-aryl, hydroxyl, carboxyl, nitro, amino, furyl, furylalkyl, alkylfuryl, hydroxyalkylfurylalkyl, isocyanate, formyl, halocarbonyl, thiol and/or alkylthio, and R^{a} is an alkyl which may optionally be substituted with C₁-C₂₀-alkyl, C₂-C₂₀-alkenyl, C₂-C₂₀-alkynyl, C₅-C₂₄-aryl, hydroxyl, carboxyl, nitro, amino, furyl, furylalkyl, alkylfuryl, hydroxyalkylfurylalkyl, isocyanate, formyl, halocarbonyl, thiol and/or alkylthio.

The designation “alkenylcarbonyloxyalkyl” represents a group —R^{b}—O—C(═O)R^{b}, where R^{b} is an alkylene as defined above which may optionally be substituted with C₁-C₂₀-alkyl, C₂-C₂₀-alkenyl, C₂-C₂₀-alkynyl, C₅-C₂₄-aryl, hydroxyl, carboxyl, nitro, amino, furyl, furylalkyl, alkylfuryl, hydroxyalkylfurylalkyl, isocyanate, formyl, halocarbonyl, thiol and/or alkylthio, and R^{b} is an alkenyl which may optionally be substituted with C₁-C₂₀-alkyl, C₂-C₂₀-alkenyl, C₂-C₂₀-alkynyl, C₅-C₂₄-aryl, hydroxyl, carboxyl, nitro, amino, furyl, furylalkyl, alkylfuryl, hydroxyalkylfurylalkyl, isocyanate, formyl, halocarbonyl, thiol and/or alkylthio.

The designation “alkylcarbonyloxyalkenyl” represents a group —R^{d}—O—C(═O)R^{a}, where R^{d} is an alkenylene as defined above which may optionally be substituted with C₁-C₂₀-alkyl, C₂-C₂₀-alkenyl, C₂-C₂₀-alkynyl, C₅-C₂₄-aryl, hydroxyl, carboxyl, nitro, amino, furyl, furylalkyl, alkylfuryl, hydroxyalkylfurylalkyl, isocyanate, formyl, halocarbonyl, thiol and/or alkylthio, and R^{a} is an alkyl which may optionally be substituted with C₁-C₂₀-alkyl, C₂-C₂₀-alkenyl, C₂-C₂₀-alkynyl, C₅-C₂₄-aryl, hydroxyl, carboxyl, nitro, amino, furyl, furylalkyl, alkylfuryl, hydroxyalkylfurylalkyl, isocyanate, formyl, halocarbonyl, thiol and/or alkylthio.

The designation “isocyanate” represents a group —N═C═O. The designation “isocyanatoalkyl” represents a group —R^{a}-isocyanate, where R^{a} is an alkylene which may optionally be substituted with C₁-C₂₀-alkyl, C₂-C₂₀-alkenyl, C₂-C₂₀-alkynyl, C₅-C₂₄-aryl, hydroxyl, carboxyl, nitro, amino, furyl, furylalkyl, alkylfuryl, hydroxyalkylfurylalkyl, isocyanate, formyl, halocarbonyl, thiol and/or alkylthio.

The designation “nitro” represents a group —NO₂.

The designation “cyano” represents a group —CN. The designation “imino” represents a group C(═NH)R⁹, where R⁹ is an alkyl, alkylene or aryl which may optionally be substituted with C₁-C₂₀-alkyl, C₂-C₂₀-alkenyl, C₂-C₂₀-alkynyl, C₅-C₂₄-aryl, hydroxyl, carboxyl, nitro, amino, furyl, furylalkyl, alkylfuryl, hydroxyalkylfurylalkyl, isocyanate, formyl, halocarbonyl, thiol and/or alkylthio.

The designation “thiol” or “sulfhydryl” represents a group —SH.

The designation “alkylthiol” represents a group —SR^{a}, where R^{a} is an alkyl which may optionally be substituted with C₁-C₂₀-alkyl, C₂-C₂₀-alkenyl, C₂-C₂₀-alkynyl, C₅-C₂₄-aryl, hydroxyl, carboxyl, nitro, amino, furyl, furylalkyl, alkylfuryl, hydroxyalkylfurylalkyl, isocyanate, formyl, halocarbonyl, thiol and/or alkylthio. This designation includes more particularly a group which consists of a sulfur atom which is bonded to an alkyl group. Preferred examples include methylthio (SCH₃), ethylthio (SCH₂CH₃), n-propylthio, isopropylthio, n-butylthio, isobutylthio, sec-butylthio, tert-butylthio and n-hexylthio.

The designation “thioalkyl” represents a group —R^{b}—SH, where R^{b} is an alkylene as defined above which may be optionally substituted with C₁-C₂₀-alkyl, C₂-C₂₀-alkenyl, C₂-C₂₀-alkynyl, C₅-C₂₄-aryl, hydroxyl, carboxyl, nitro, amino, furyl, furylalkyl, alkylfuryl, hydroxyalkylfurylalkyl, isocyanate, formyl, halocarbonyl, thiol and/or alkylthio.

The designation “alkylthioalkyl” represents a group —R^{b}—SR^{a}, where R^{b} is an alkylene as defined above which may be optionally substituted with C₁-C₂₀-alkyl, C₂-C₂₀-alkenyl, C₂-C₂₀-alkynyl, C₅-C₂₄-aryl, hydroxyl, carboxyl, nitro, amino, furyl, furylalkyl, alkylfuryl, hydroxyalkylfurylalkyl, isocyanate, formyl, halocarbonyl, thiol and/or alkylthio, and where R^{a} is an alkyl which may be optionally substituted with C₁-C₂₀-alkyl, C₂-C₂₀-alkenyl, C₂-C₂₀-alkynyl, C₅-C₂₄-aryl, hydroxyl, carboxyl, nitro, amino, furyl, furylalkyl, alkylfuryl, hydroxyalkylfurylalkyl, isocyanate, formyl, halocarbonyl, thiol and/or alkylthio.

The designation “sulfonic acid group” represents a group —S(═O)₂OH.

The designation “alkylsulfonyl” represents a group —S(═O)₂OR^{a}, where R^{a} is an alkyl which may be optionally substituted with C₁-C₂₀-alkyl, C₂-C₂₀-alkenyl, C₂-C₂₀-alkynyl, C₅-C₂₄-aryl, hydroxyl, carboxyl, nitro, amino, furyl, furylalkyl, alkylfuryl, hydroxyalkylfurylalkyl, isocyanate, formyl, halocarbonyl, thiol and/or alkylthio.

The designation “halogen” represents fluorine, chlorine, bromine and/or iodine.

The designation “haloalkyl” represents an alkyl radical as defined above where one or more hydrogen atoms have been replaced by a halogen as defined above. Preferred examples include chloromethyl, 1-bromoethyl, fluoromethyl, difluoromethyl, trifluoromethyl and 1,1,1-trifluoroethyl.

The designation “haloalkenyl” represents an alkenyl radical as defined above where one or more hydrogen atoms have been replaced by a halogen as defined above.

The designation “halocarbonyl” represents a group —C(═O)—Hal, where Hal represents a halogen as defined above. Preferred examples include chlorocarbonyl (—C(═O)Cl), bromocarbonyl (—C(═O)Br) and fluorocarbonyl (—C(═O)F).

The designation “haloaryl” represents an aryl radical as defined above where one or more hydrogen atoms have been replaced by a halogen as defined above.

Whenever the expression “substituted” is used in the present invention it is supposed to indicate that one or more hydrogen atoms on the atom recited in the designation using the expression “substituted” are replaced by the recited group under the precondition that the normal valency of the atom is not exceeded and that the substitution leads to a chemically stable compound, i.e., a compound which is sufficiently stable to survive isolation from the reaction mixture at a practicable degree of purity.

In the context of the present invention, the proportion of halogen-containing compounds in the polymerizable composition is preferably as low as possible and advantageously below 20.0 wt %, preferably below 10.0 wt %, more preferably below 5.0 wt % and especially below 1.0 wt %, all based on the overall weight of the polymerizable compounds. In the context of a very particularly preferred embodiment of the present invention, the polymerizable composition does not contain any halogen-containing compounds.

Furthermore, the proportion of sulfur-containing compounds in the polymerizable composition is preferably as low as possible and advantageously below 20.0 wt %, preferably below 10.0 wt %, more preferably below 5.0 wt % and especially below 1.0 wt %, all based on the overall weight of the polymerizable compounds. In the context of a very particularly preferred embodiment of the present invention, the polymerizable composition does not contain any sulfur-containing compounds.

In addition, the proportion of nitrogen-containing compounds in the polymerizable composition is preferably as low as possible and advantageously below 20.0 wt %, preferably below 10.0 wt %, more preferably below 5.0 wt % and especially below 1.0 wt %, all based on the overall weight of the polymerizable compounds. In the context of a very particularly preferred embodiment of the present invention, the polymerizable composition does not contain any nitrogen-containing compounds.

In a first particularly preferred version of the present invention, R¹⁷ is not hydrogen.

In the context of a preferred embodiment of the present invention, the resin is obtainable by polymerizing a composition which contains at least one compound of the formula (I) and/or of formula (II), wherein
n is an integer between 0 and 5,
t and s are each independently an integer between 1 and 5 and preferably 1 or 2,
w and z are each independently 0 or 1,
X and Y are each independently O, S or N—R²¹,
R¹, R², R³, R⁴, R⁵, R⁶, R⁷, R⁸, R⁹, R¹⁰, R¹¹, R¹², R¹³, R¹⁴, R¹⁵, R¹⁶, R¹⁸, R¹⁹ and R²¹ are each independently hydrogen, C₁-C₂₀-alkyl, carboxyaldehyde, hydroxyalkyl, carboxyl, amino, nitro, alkylamino, aminoalkyl, alkyloxyalkyl, alkylaminoalkyl, alkylcarboxy, alkenylcarboxy, furyl, furylalkyl, hydroxyalkylfurylalkyl, alkyloxy, alkenyloxy, alkylcarbonylalkenyl, oxiranyl, alkenylcarbonyl, alkylcarbonyloxyalkyl, alkyloxycarbonylalkenyl, alkenylcarbonyloxyalkyl, isocyanate, isocyanatoalkyl, alkylcarbonyl, halocarbonyl, haloalkyl, haloaryl, haloalkenyl, imino, thioalkyl, alkylthioalkyl and/or cyano, preferably hydrogen, C₁-C₂₀-alkyl, carboxyaldehyde, hydroxyalkyl, carboxyl, alkylamino, aminoalkyl, alkylaminoalkyl, alkyloxy, alkyloxyalkyl, furylalkyl, hydroxyalkylfurylalkyl, alkenyloxy, alkylcarbonylalkenyl, alkenylcarbonyl, alkylcarbonaloxyalkyl, alkyloxycarbonylalkenyl, alkenylcarbonyloxyalkyl, alkylcarboxy, alkenylcarboxy and/or alkylcarbonyl, more preferably hydrogen, C₁-C₁₀-alkyl, carboxyaldehyde, hydroxyalkyl, alkylamino, aminoalkyl, alkylaminoalkyl, alkyloxy, alkyloxyalkyl, furylalkyl, hydroxyalkylfurylalkyl, carboxyl, alkenyloxy, alkylcarboxy, alkenylcarboxy, alkylcarbonyl and/or alkylenecarbonyl, especially hydrogen, C₁-C₁₀-alkyl, carboxyaldehyde, hydroxyalkyl, aminoalkyl, alkylaminoalkyl, alkyloxyalkyl, furylalkyl, hydroxyalkylfurylalkyl and/or carboxyl, wherein every group can be substituted with C₁-C₂₀-alkyl, C₂-C₂₀-alkenyl, C₂-C₂₀-alkynyl, C₅-C₂₄-aryl, hydroxyl, carboxyl, nitro, amino, furyl, furylalkyl, alkylfuryl, hydroxyalkylfurylalkyl, isocyanate, formyl, halocarbonyl, thiol and/or alkylthio,
R¹⁷ and R²⁰ are each independently C₁-C₂₀-alkyl, carboxaldehyde, hydroxyalkyl, carboxyl, amino, nitro, alkylamino, aminoalkyl, alkyloxyalkyl, alkylaminoalkyl, alkylcarboxy, alkenylcarboxy, furyl, furylalkyl, hydroxyalkylfurylalkyl, alkyloxy, akenyloxy, alkylcarbonylalkenyl, oxiranyl, alkenylcarbonyl, alkylcarbonyloxyalkyl, alkyloxycarbonylalkenyl, alkenylcarbonyloxyalkyl, isocyanate, isocyanatoalkyl and/or alkylcarbonyl, preferably C₁-C₂₀-alkyl, carboxaldehyde, hydroxyalkyl, carboxyl, alkylamino, aminoalkyl, alkylaminoalkyl, alkyloxy, alkyloxyalkyl, furylalkyl, hydroxyalkylfurylalkyl, alkenyloxy, alkylcarbonylalkenyl, alkenylcarbonyl, alkylcarbonyloxyalkyl, alkyloxycarbonylalkenyl, alkenylcarbonyloxyalkyl, alkylcarboxy, alkenylcarboxy and/or alkylcarbonyl, more preferably C₁-C₁₀-alkyl, carboxaldehyde, hydroxyalkyl, alkylamino, aminoalkyl, alkylaminoalkyl, carboxyl, alkyloxy, alkyloxyalkyl, furylalkyl, hyrdoxyalkylfurylalkyl, alkenyloxy, alkylcarboxy, alkenylcarboxy, alkylcarbonyl and/or alkenylcarbonyl, especially C₁-C₁₀-alkyl, carboxaldehyde, hydroxyalkyl, aminoalkyl and/or carboxyl, wherein every group can be substituted with C₁-C₂₀-alkyl, C₂-C₂₀-alkenyl, C₂-C₂₀-alkynyl, C₅-C₂₄-aryl, hydroxyl, carboxyl, nitro, amino, furyl, furylalkyl, alkylfuryl, hydroxyalkylfurylalkyl, isocyanate, formyl, halocarbonyl, thiol and/or alkylthio, and

wherein the broken line depicts a double bond.

In the context of a further preferred embodiment of the present invention, the resin is obtainable by polymerizing a composition which contains a compound of the formula (I) and/or of formula (II), wherein
n is 0, 1, 2, 3, 4 or 5,
t and s are each independently 1 or 2,
w and z are each independently 0 or 1,
X and Y are each independently O, S or N—R²¹,
R², R³, R⁴, R⁵, R⁶, R⁷, R⁹, R¹⁰, R¹¹, R¹², R¹³, R¹⁴, R¹⁵, R¹⁶, R¹⁸, R¹⁹ and R²¹ are each independently hydrogen, C₁-C₂-alkyl, carboxaldehyde, hydroxyalkyl, carboxyl, aminoalkyl, alkylaminoalkyl, hydroxyalkylfurylalkyl, alkyloxy, alkyloxyalkyl, alkylcarbonylalkenyl, alkylcarbonyloxyalkyl, alkyloxycarbonylalkenyl, alkenylcarbonyloxyalkyl, oxiranyl, isocyanate, isocyanatoalkyl, alkylcarboxy, alkenylcarboxy, alkylcarbonyl, alkenylcarbonyl, halocarbonyl, haloalkyl, haloaryl, haloalkenyl, imino, thioalkyl, alkylthioalkyl and/or cyano, wherein every group can be substituted with C₁-C₂-alkyl, C₂-C₄-alkenyl, C₂-C₄-alkynyl, hydroxyl, carboxyl, nitro, amino, alkylfuryl, hydroxyalkylfurylalkyl, isocyanate, formyl, halocarbonyl and/or thiol,
R¹, R⁸, R¹⁷ and R²⁰ are each independently C₁-C₂-alkyl, carboxaldehyde, hydroxyalkyl, carboxyl, aminoalkyl, alkylaminoalkyl, hydroxyalkylfurylalkyl, alkyloxy, alkoxyalkyl, alkylcarbonylalkenyl, alkylcarbonyloxyalkyl, alkyloxycarbonylalkenyl, akenylcarbonyloxyalkyl, oxiranyl, isocyanate, isocyanatoalkyl, alkylcarboxy, alkenylcarboxy, alkylcarbonyl, alkenylcarbonyl, halocarbonyl, haloalkyl, haloaryl, haloalkenyl, imino, thioalkyl, alkylthioalkyl and/or cyano, wherein every group can be substituted with C₁-C₂-alkyl, C₂-C₄-alkenyl, C₂-C₄-alkynyl, hydroxyl, carboxyl, nitro, amino, alkylfuryl, hydroxyalkylfurylalkyl, isocyanate, formyl, halocarbonyl and/or thiol, and

wherein the broken line depicts a double bond.

In the context of yet a further preferred embodiment of the present invention, the resin is obtainable by polymerizing a composition containing a compound of formula (I) and/or formula (II), wherein
n is an integer between 0 and 5,
t and s are each independently 1 or 2,
w and z are each independently 0 or 1,
X and Y are each independently O, S or N—R²¹,
R², R³, R⁴, R⁵, R⁶, R⁷, R⁹, R¹⁰, R¹¹, R¹², R¹³, R¹⁴, R¹⁵, R¹⁶, R¹⁸, R¹⁹ and R²¹ are each independently hydrogen, C₁-C₂ alkyl, carboxaldehyde, hydroxyalkyl, carboxyl, aminoalkyl, alkylaminoalkyl, hydroxyalkylfurylalkyl, alkoxyalkyl, oxiranyl and/or isocyanate,
R¹, R⁸, R¹⁷ and R²⁰ are each independently C₁-C₂ alkyl, carboxaldehyde, hydroxyalkyl, carboxyl, aminoalkyl, alkylaminoalkyl, hydroxyalkylfurylalkyl, alkoxyalkyl, oxiranyl and/or isocyanate, and

wherein the broken line depicts a double bond.

In the context of yet a further preferred embodiment of the present invention, the resin is obtainable by polymerizing a composition containing a compound of formula (I) and/or formula (II), wherein
n is 0, 1, 2, 3, 4 or 5,
t is 1 or 2,
s is 1 or 2,
w is 0 or 1,
z is 0 or 1,
X is O, S or N—R²¹,
Y is O, S or N—R²¹,
R¹ is hydrogen, C₁-C₈ alkyl, C₂-C₈ alkenyl, carboxaldehyde, hydroxyalkyl, carboxyl, formyl, aminoalkyl, alkylaminoalkyl, furylalkyl, hydroxyalkylfurylalkyl, alkylcarboxy, alkenylcarboxy, alkylcarbonyloxyalkyl, alkenylcarbonyloxyalkyl, isocyanate or isocyanatoalkyl, especially —CH₃, —C₂H₅, —C₃H₇, —C₄H₉, —CH₂═CH, —CH₂OH, —CH₂NH₂, —COON, —C(═O)H, —NO₂, —C₂H₃O, —CH₂NH₂, —N═C═O, —CH₂—N═C═O, —O—CH═CH₂, —C(═O)OCH₃, —C(═O)OC₂H₅, —CH₂-furyl-CH₂OH or —CH₂—O—C(═O)—CH═CH₂,
R² is hydrogen, C₁-C₈ alkyl, C₂-C₈ alkenyl, carboxaldehyde, hydroxyalkyl, carboxyl, formyl, aminoalkyl, alkylaminoalkyl, furylalkyl, hydroxyalkylfurylalkyl, alkylcarboxy, alkenylcarboxy, alkylcarbonyloxyalkyl, alkenylcarbonyloxyalkyl, isocyanate or isocyanatoalkyl, especially —CH₃, —C₂H₅, —C₃H₇, —C₄H₉, —CH₂═CH, —CH₂OH, —CH₂NH₂, —COON, —C(═O)H, —NO₂, —C₂H₃O, —CH₂NH₂, —N═C═O, —CH₂—N═C═O, —O—CH═CH₂, —C(═O)OCH₃, —C(═O)OC₂H₅, —CH₂-furyl-CH₂OH or —CH₂—O—C(═O)—CH═CH₂,
R³ is hydrogen, C₁-C₈ alkyl, C₂-C₈ alkenyl, carboxaldehyde, hydroxyalkyl, carboxyl, formyl, aminoalkyl, alkylaminoalkyl, furylalkyl, hydroxyalkylfurylalkyl, alkylcarboxy, alkenylcarboxy, alkylcarbonyloxyalkyl, alkenylcarbonyloxyalkyl, isocyanate or isocyanatoalkyl, especially —CH₃, —C₂H₅, —C₃H₇, —C₄H₉, —CH₂═CH, —CH₂OH, —CH₂NH₂, —COON, —C(═O)H, —NO₂, —C₂H₃O, —CH₂NH₂, —N═C═O, —CH₂—N═C═O, —O—CH═CH₂, —C(═O)OCH₃, —C(═O)OC₂H₅, —CH₂-furyl-CH₂OH or —CH₂—O—C(═O)—CH═CH₂,
R⁴ is hydrogen, C₁-C₈ alkyl, C₂-C₈ alkenyl, carboxaldehyde, hydroxyalkyl, carboxyl, formyl, aminoalkyl, alkylaminoalkyl, furylalkyl, hydroxyalkylfurylalkyl, alkylcarboxy, alkenylcarboxy, alkylcarbonyloxyalkyl, alkenylcarbonyloxyalkyl, isocyanate or isocyanatoalkyl, especially —CH₃, —C₂H₅, —C₃H₇, —C₄H₉, —CH₂═CH, —CH₂OH, —CH₂NH₂, —COON, —C(═O)H, —NO₂, —C₂H₃O, —CH₂NH₂, —N═C═O, —CH₂—N═C═O, —O—CH═CH₂, —C(═O)OCH₃, —C(═O)OC₂H₅, —CH₂-furyl-CH₂OH or —CH₂—O—C(═O)—CH═CH₂,
R⁵ is hydrogen, C₁-C₈ alkyl, C₂-C₈ alkenyl, carboxaldehyde, hydroxyalkyl, carboxyl, formyl, aminoalkyl, alkylaminoalkyl, furylalkyl, hydroxyalkylfurylalkyl, alkylcarboxy, alkenylcarboxy, alkylcarbonyloxyalkyl, alkenylcarbonyloxyalkyl, isocyanate or isocyanatoalkyl, especially —CH₃, —C₂H₅, —C₃H₇, —C₄H₉, —CH₂═CH, —CH₂OH, —CH₂NH₂, —COON, —C(═O)H, —NO₂, —C₂H₃O, —CH₂NH₂, —N═C═O, —CH₂—N═C═O, —O—CH═CH₂, —C(═O)OCH₃, —C(═O)OC₂H₅, —CH₂-furyl-CH₂OH or —CH₂—O—C(═O)—CH═CH₂,
R⁶ is hydrogen, C₁-C₈ alkyl, C₂-C₈ alkenyl, carboxaldehyde, hydroxyalkyl, carboxyl, formyl, aminoalkyl, alkylaminoalkyl, furylalkyl, hydroxyalkylfurylalkyl, alkylcarboxy, alkenylcarboxy, alkylcarbonyloxyalkyl, alkenylcarbonyloxyalkyl, isocyanate or isocyanatoalkyl, especially —CH₃, —C₂H₅, —C₃H₇, —C₄H₉, —CH₂═CH, —CH₂OH, —CH₂NH₂, —COON, —C(═O)H, —NO₂, —C₂H₃O, —CH₂NH₂, —N═C═O, —CH₂—N═C═O, —O—CH═CH₂, —C(═O)OCH₃, —C(═O)OC₂H₅, —CH₂-furyl-CH₂OH or —CH₂—O—C(═O)—CH═CH₂,
R⁷ is hydrogen, C₁-C₈ alkyl, C₂-C₈ alkenyl, carboxaldehyde, hydroxyalkyl, carboxyl, formyl, aminoalkyl, alkylaminoalkyl, furylalkyl, hydroxyalkylfurylalkyl, alkylcarboxy, alkenylcarboxy, alkylcarbonyloxyalkyl, alkenylcarbonyloxyalkyl, isocyanate or isocyanatoalkyl, especially —CH₃, —C₂H₅, —C₃H₇, —C₄H₉, —CH₂═CH, —CH₂OH, —CH₂NH₂, —COON, —C(═O)H, —NO₂, —C₂H₃O, —CH₂NH₂, —N═C═O, —CH₂—N═C═O, —O—CH═CH₂, —C(═O)OCH₃, —C(═O)OC₂H₅, —CH₂-furyl-CH₂OH or —CH₂—O—C(═O)—CH═CH₂,
R⁸ is hydrogen, C₁-C₈ alkyl, C₂-C₈ alkenyl, carboxaldehyde, hydroxyalkyl, carboxyl, formyl, aminoalkyl, alkylaminoalkyl, furylalkyl, hydroxyalkylfurylalkyl, alkylcarboxy, alkenylcarboxy, alkylcarbonyloxyalkyl, alkenylcarbonyloxyalkyl, isocyanate or isocyanatoalkyl, especially —CH₃, —C₂H₅, —C₃H₇, —C₄H₉, —CH₂═CH, —CH₂OH, —CH₂NH₂, —COON, —C(═O)H, —NO₂, —C₂H₃O, —CH₂NH₂, —N═C═O, —CH₂—N═C═O, —O—CH═CH₂, —C(═O)OCH₃, —C(═O)OC₂H₅, —CH₂-furyl-CH₂OH or —CH₂—O—C(═O)—CH═CH₂,
R⁹ is hydrogen, C₁-C₈ alkyl, C₂-C₈ alkenyl, carboxaldehyde, hydroxyalkyl, carboxyl, formyl, aminoalkyl, alkylaminoalkyl, furylalkyl, hydroxyalkylfurylalkyl, alkylcarboxy, alkenylcarboxy, alkylcarbonyloxyalkyl, alkenylcarbonyloxyalkyl, isocyanate or isocyanatoalkyl, especially —CH₃, —C₂H₅, —C₃H₇, —C₄H₉, —CH₂═CH, —CH₂OH, —CH₂NH₂, —COON, —C(═O)H, —NO₂, —C₂H₃O, —CH₂NH₂, —N═C═O, —CH₂—N═C═O, —O—CH═CH₂, —C(═O)OCH₃, —C(═O)OC₂H₅, —CH₂-furyl-CH₂OH or —CH₂—O—C(═O)—CH═CH₂,
R¹⁹ is hydrogen, C₁-C₈ alkyl, C₂-C₈ alkenyl, carboxaldehyde, hydroxyalkyl, carboxyl, formyl, aminoalkyl, alkylaminoalkyl, furylalkyl, hydroxyalkylfurylalkyl, alkylcarboxy, alkenylcarboxy, alkylcarbonyloxyalkyl, alkenylcarbonyloxyalkyl, isocyanate or isocyanatoalkyl, especially —CH₃, —C₂H₅, —C₃H₇, —C₄H₉, —CH₂═CH, —CH₂OH, —CH₂NH₂, —COON, —C(═O)H, —NO₂, —C₂H₃O, —CH₂NH₂, —N═C═O, —CH₂—N═C═O, —O—CH═CH₂, —C(═O)OCH₃, —C(═O)OC₂H₅, —CH₂-furyl-CH₂OH or —CH₂—O—C(═O)—CH═CH₂,
R¹¹ is hydrogen, C₁-C₈ alkyl, C₂-C₈ alkenyl, carboxaldehyde, hydroxyalkyl, carboxyl, formyl, aminoalkyl, alkylaminoalkyl, furylalkyl, hydroxyalkylfurylalkyl, alkylcarboxy, alkenylcarboxy, alkylcarbonyloxyalkyl, alkenylcarbonyloxyalkyl, isocyanate or isocyanatoalkyl, especially —CH₃, —C₂H₅, —C₃H₇, —C₄H₉, —CH₂═CH, —CH₂OH, —CH₂NH₂, —COON, —C(═O)H, —NO₂, —C₂H₃O, —CH₂NH₂, —N═C═O, —CH₂—N═C═O, —O—CH═CH₂, —C(═O)OCH₃, —C(═O)OC₂H₅, —CH₂-furyl-CH₂OH or —CH₂—O—C(═O)—CH═CH₂,
R¹² is hydrogen, C₁-C₈ alkyl, C₂-C₈ alkenyl, carboxaldehyde, hydroxyalkyl, carboxyl, formyl, aminoalkyl, alkylaminoalkyl, furylalkyl, hydroxyalkylfurylalkyl, alkylcarboxy, alkenylcarboxy, alkylcarbonyloxyalkyl, alkenylcarbonyloxyalkyl, isocyanate or isocyanatoalkyl, especially —CH₃, —C₂H₅, —C₃H₇, —C₄H₉, —CH₂═CH, —CH₂OH, —CH₂NH₂, —COON, —C(═O)H, —NO₂, —C₂H₃O, —CH₂NH₂, —N═C═O, —CH₂—N═C═O, —O—CH═CH₂, —C(═O)OCH₃, —C(═O)OC₂H₅, —CH₂-furyl-CH₂OH or —CH₂—O—C(═O)—CH═CH₂,
R¹³ is hydrogen, C₁-C₈ alkyl, C₂-C₈ alkenyl, carboxaldehyde, hydroxyalkyl, carboxyl, formyl, aminoalkyl, alkylaminoalkyl, furylalkyl, hydroxyalkylfurylalkyl, alkylcarboxy, alkenylcarboxy, alkylcarbonyloxyalkyl, alkenylcarbonyloxyalkyl, isocyanate or isocyanatoalkyl, especially —CH₃, —C₂H₅, —C₃H₇, —C₄H₉, —CH₂═CH, —CH₂OH, —CH₂NH₂, —COON, —C(═O)H, —NO₂, —C₂H₃O, —CH₂NH₂, —N═C═O, —CH₂—N═C═O, —O—CH═CH₂, —C(═O)OCH₃, —C(═O)OC₂H₅, —CH₂-furyl-CH₂OH or —CH₂—O—C(═O)—CH═CH₂,
R¹⁴ is hydrogen, C₁-C₈ alkyl, C₂-C₈ alkenyl, carboxaldehyde, hydroxyalkyl, carboxyl, formyl, aminoalkyl, alkylaminoalkyl, furylalkyl, hydroxyalkylfurylalkyl, alkylcarboxy, alkenylcarboxy, alkylcarbonyloxyalkyl, alkenylcarbonyloxyalkyl, isocyanate or isocyanatoalkyl, especially —CH₃, —C₂H₅, —C₃H₇, —C₄H₉, —CH₂═CH, —CH₂OH, —CH₂NH₂, —COON, —C(═O)H, —NO₂, —C₂H₃O, —CH₂NH₂, —N═C═O, —CH₂—N═C═O, —O—CH═CH₂, —C(═O)OCH₃, —C(═O)OC₂H₅, —CH₂-furyl-CH₂OH or —CH₂—O—C(═O)—CH═CH₂,
R¹⁵ is hydrogen, C₁-C₈ alkyl, C₂-C₈ alkenyl, carboxaldehyde, hydroxyalkyl, carboxyl, formyl, aminoalkyl, alkylaminoalkyl, furylalkyl, hydroxyalkylfurylalkyl, alkylcarboxy, alkenylcarboxy, alkylcarbonyloxyalkyl, alkenylcarbonyloxyalkyl, isocyanate or isocyanatoalkyl, especially —CH₃, —C₂H₅, —C₃H₇, —C₄H₉, —CH₂═CH, —CH₂OH, —CH₂NH₂, —COON, —C(═O)H, —NO₂, —C₂H₃O, —CH₂NH₂, —N═C═O, —CH₂—N═C═O, —O—CH═CH₂, —C(═O)OCH₃, —C(═O)OC₂H₅, —CH₂-furyl-CH₂OH or —CH₂—O—C(═O)—CH═CH₂,
R¹⁶ is hydrogen, C₁-C₈ alkyl, C₂-C₈ alkenyl, carboxaldehyde, hydroxyalkyl, carboxyl, formyl, aminoalkyl, alkylaminoalkyl, furylalkyl, hydroxyalkylfurylalkyl, alkylcarboxy, alkenylcarboxy, alkylcarbonyloxyalkyl, alkenylcarbonyloxyalkyl, isocyanate or isocyanatoalkyl, especially —CH₃, —C₂H₅, —C₃H₇, —C₄H₉, —CH₂═CH, —CH₂OH, —CH₂NH₂, —COON, —C(═O)H, —NO₂, —C₂H₃O, —CH₂NH₂, —N═C═O, —CH₂—N═C═O, —O—CH═CH₂, —C(═O)OCH₃, —C(═O)OC₂H₅, —CH₂-furyl-CH₂OH or —CH₂—O—C(═O)—CH═CH₂,
R¹⁷ is hydrogen, C₁-C₈ alkyl, C₂-C₈ alkenyl, carboxaldehyde, hydroxyalkyl, carboxyl, formyl, aminoalkyl, alkylaminoalkyl, furylalkyl, hydroxyalkylfurylalkyl, alkylcarboxy, alkenylcarboxy, alkylcarbonyloxyalkyl, alkenylcarbonyloxyalkyl, isocyanate or isocyanatoalkyl, especially —CH₃, —C₂H₅, —C₃H₇, —C₄H₉, —CH₂═CH, —CH₂OH, —CH₂NH₂, —COON, —C(═O)H, —NO₂, —C₂H₃O, —CH₂NH₂, —N═C═O, —CH₂—N═C═O, —O—CH═CH₂, —C(═O)OCH₃, —C(═O)OC₂H₅, —CH₂-furyl-CH₂OH or —CH₂—O—C(═O)—CH═CH₂,
R¹⁸ is hydrogen, C₁-C₈ alkyl, C₂-C₈ alkenyl, carboxaldehyde, hydroxyalkyl, carboxyl, formyl, aminoalkyl, alkylaminoalkyl, furylalkyl, hydroxyalkylfurylalkyl, alkylcarboxy, alkenylcarboxy, alkylcarbonyloxyalkyl, alkenylcarbonyloxyalkyl, isocyanate or isocyanatoalkyl, especially —CH₃, —C₂H₅, —C₃H₇, —C₄H₉, —CH₂═CH, —CH₂OH, —CH₂NH₂, —COON, —C(═O)H, —NO₂, —C₂H₃O, —CH₂NH₂, —N═C═O, —CH₂—N═C═O, —O—CH═CH₂, —C(═O)OCH₃, —C(═O)OC₂H₅, —CH₂-furyl-CH₂OH or —CH₂—O—C(═O)—CH═CH₂,
R¹⁹ is hydrogen, C₁-C₈ alkyl, C₂-C₈ alkenyl, carboxaldehyde, hydroxyalkyl, carboxyl, formyl, aminoalkyl, alkylaminoalkyl, furylalkyl, hydroxyalkylfurylalkyl, alkylcarboxy, alkenylcarboxy, alkylcarbonyloxyalkyl, alkenylcarbonyloxyalkyl, isocyanate or isocyanatoalkyl, especially —CH₃, —C₂H₅, —C₃H₇, —C₄H₉, —CH₂═CH, —CH₂OH, —CH₂NH₂, —COON, —C(═O)H, —NO₂, —C₂H₃O, —CH₂NH₂, —N═C═O, —CH₂—N═C═O, —O—CH═CH₂, —C(═O)OCH₃, —C(═O)OC₂H₅, —CH₂-furyl-CH₂OH or —CH₂—O—C(═O)—CH═CH₂,
R²⁰ is hydrogen, C₁-C₈ alkyl, C₂-C₈ alkenyl, carboxaldehyde, hydroxyalkyl, carboxyl, formyl, aminoalkyl, alkylaminoalkyl, furylalkyl, hydroxyalkylfurylalkyl, alkylcarboxy, alkenylcarboxy, alkylcarbonyloxyalkyl, alkenylcarbonyloxyalkyl, isocyanate or isocyanatoalkyl, especially —CH₃, —C₂H₅, —C₃H₇, —C₄H₉, —CH₂═CH, —CH₂OH, —CH₂NH₂, —COON, —C(═O)H, —NO₂, —C₂H₃O, —CH₂NH₂, —N═C═O, —CH₂—N═C═O, —O—CH═CH₂, —C(═O)OCH₃, —C(═O)OC₂H₅, —CH₂-furyl-CH₂OH or —CH₂—O—C(═O)—CH═CH₂,
R²¹ is hydrogen, C₁-C₈ alkyl, C₂-C₈ alkenyl, carboxaldehyde, hydroxyalkyl, carboxyl, formyl, aminoalkyl, alkylaminoalkyl, furylalkyl, hydroxyalkylfurylalkyl, alkylcarboxy, alkenylcarboxy, alkylcarbonyloxyalkyl, alkenylcarbonyloxyalkyl, isocyanate or isocyanatoalkyl, especially —CH₃, —C₂H₅, —C₃H₇, —C₄H₉, —CH₂═CH, —CH₂OH, —CH₂NH₂, —COON, —C(═O)H, —NO₂, —C₂H₃O, —CH₂NH₂, —N═C═O, —CH₂—N═C═O, —O—CH═CH₂, —C(═O)OCH₃, —C(═O)OC₂H₅, —CH₂-furyl-CH₂OH or —CH₂—O—C(═O)—CH═CH₂,
every R may be optionally substituted with C₁-C₂₀ alkyl, C₂-C₂₀ alkenyl, C₂-C₂₀ alkynyl, C₅-C₂₄ aryl, hydroxyl, carboxyl, nitro, amino, furyl, fuylalkyl, alkylfuryl, hydroxyalkylfurylalkyl, isocyanate, formyl, halocarbonyl, thiol and/or alkylthio, especially with C₁-C₂ alkyl, C₂-C₄ alkenyl, C₂-C₄ alkynyl, hydroxyl, carboxyl, nitro, amino, alkylfuryl, hydroxyalkylfurylalkyl, isocyanate, formyl, halocarbonyl and/or thiol, and

wherein the broken line depicts a double bond.

Preferred monomers for preparing the resin include 2,5-bis(hydroxymethyl)furan, 2,3,5-tris(hydroxymethyl)furan, 5-methyl-2-furfuryl alcohol, 3-hydroxymethyl-5-methyl-2-furfuryl alcohol, 2,2′-(hydroxymethyl)difurylmethane, 2,2′,3,3′-(hydroxymethyl)difurylmethane, 2,2′,4,4′-(hydroxymethyl)difurylmethane, 5-hydroxymethyl-α-(methyl)furfuryl alcohol, 5-hydroxymethyl-2-furancarboxaldehyde, 3,5-hydroxymethyl-2-furancarboxaldehyde, 4,5-hydroxymethyl-2-furancarboxaldehyde, 5-methyl-2-furancarboxaldehyde, 3-hydroxymethyl-5-methyl-2-furancarboxaldehyde, 5-nitrofurfuraldehyde, 2,5-bis(carboxaldehyde)furan, 3-hydroxymethyl-2,5-bis(carboxaldehyde)furan, 4-hydroxymethyl-2,5-bis(carboxaldehyde)furan, 5-hydroxymethyl-2-furoic acid, 5-methyl-2-furoic acid, 5-carboxaldehyde-2-furoic acid, 2,5-furandicarboxylic acid, 2,5-furoyl dichloride, dimethyl 2,5-furandicarboxylate, 5-hydroxymethyl-2-furfurylamine, 5-methyl-2-furfurylamine, 5-carboxaldehyde-2-furfurylamine, 5-carboxy-2-furfurylamine, 2,5-bis(aminomethyl)furan, 5-methyl-2-vinyl furoate, 5-tert-butyl-2-vinyl furoate, 5-methyl-2-vinylfuran, 5-methyl-2-furfurylideneacetone, 5-methyl-2-furyloxirane, 5-methylfurfuryl vinyl ether, 5-hydroxymethyl-2-ethylfuran acrylate, bis(2,5-isocyanatomethyl)furan and bis(2,5-isocyanato)furan and also mixtures thereof.

In a preferred embodiment of the present invention, the polymerizable composition comprises 2,5-bis(hydroxymethyl)furan (BHMF).

In a further preferred embodiment of the present invention, the polymerizable composition comprises 2,3,5-tris(hydroxymethyl)furan (THMF). In a further preferred embodiment of the present invention, the polymerizable composition comprises 2,2′-hydroxymethyldifurylmethane (HMDM). In a further preferred embodiment of the present invention, the polymerizable composition comprises 5-hydroxymethyl-2-furfurylamine. In a further preferred embodiment of the present invention, the polymerizable composition comprises 5-hydroxymethyl-2-furancarboxaldehyde. In a further preferred embodiment of the present invention, the polymerizable composition comprises 5-methyl-2-furfuryl alcohol. In a further preferred embodiment of the present invention, the polymerizable composition comprises 5-hydroxymethyl-α-(methyl)furfuryl alcohol. In a further preferred embodiment of the present invention, the polymerizable composition comprises 2,2′,3,3′-(hydroxymethyl)difurylmethane. In a further preferred embodiment of the present invention, the polymerizable composition comprises 2,2′,4,4′-(hydroxymethyl)difuryl methane.

In a further preferred embodiment of the present invention, the polymerizable composition comprises 2,5-bis(hydroxymethyl)furan (BHMF), 2,3,5-tris(hydroxymethyl)furan (THMF) and/or 2,2′-hydroxymethyldifurylmethane (HMDM).

In a further preferred embodiment of the present invention, the polymerizable composition comprises 2,5-bis(hydroxymethyl)furan (BHMF), 2,3,5-tris(hydroxymethyl)furan (THMF), 2,2′-(hydroxymethyl)difurylmethane (HMDM) and/or condensation products of BHMF, THMF and/or HMDM.

The designation “condensation product” as used herein represents a compound of formula (IV)

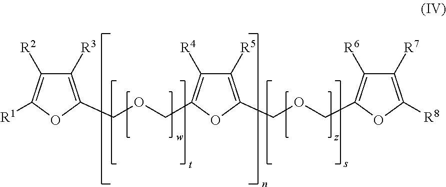

where
n is preferably between 0 and 5, especially 1, 2, 3 or 4,
t is 1 or 2,
s is 1 or 2,
w is 0 or 1,
z is 0 or 1,
R², R³, R⁴, R⁵, R⁶, R⁷ are each independently hydrogen, methyl, a hydroxyalkyl or a hydroxyalkylfurylalkyl,
R¹ and R⁸ are each independently methyl, a hydroxyalkyl or a hydroxyalkylfurylalkyl.

Preferably, R², R³, R⁴, R⁵, R⁶, R⁷ are each independently —H, —CH₃, —CH₂OH or —CH₂-furyl-CH₂OH (=hydroxymethylfurylmethyl) and R¹ and R⁸ are each independently —CH₃, —CH₂OH or —CH₂-furyl-CH₂OH.

In a further preferred embodiment of the present invention, the polymerizable composition comprises a compound of formula (I) and/or (II) where n, t, s, w, z, X, Y, R², R³, R⁴, R⁵, R⁶, R⁷, R⁸, R⁹, R¹⁰, R¹¹, R¹², R¹³, R¹⁴, R¹⁵, R¹⁶, R¹⁷, R¹⁸, R¹⁹, R²⁰, R²¹ are each as defined above and where the broken line depicts a double bond, under the precondition that R¹⁷ and R²⁰ are not a C₁-C₂₀ alkyl group and preferably not methyl, and/or under the precondition that the compound is not 2,5-dimethylfuran, 2,4-dimethylfuran, 2-acetyl-5-methylfuran, 2,5-dimethyl-3-acetylfuran, 2,3,5-trimethylfuran, 2-vinyl-3-methylfuran, 2-methylbenzofuran, dimethylbenzofuran, dibenzofuran, 2,3-dimethyl-5-ethylfuran, 3,4-dimethyl-5-ethylfuran, 2-ethyl-2,3-dihydro-5-methylfuran, 2,5-tetrahydrodimethylfuran, 2-methyltetrahydrofuran-3-one, 2,5-dimethyltetrahydrofuran-3-one, 2-acetyltetrahydrofuran-3-one, 4-methyl-2-furoic acid, 2-(5-methylfuryl) methyl ketone, 4-methylfurfural, 5-methylfurfural, 2-methyl-3-furfural, 3-methyl-2-furfural, 5-hydroxymethyl-2-furfural, bisfurfuryl-2-furan or 2,5-difurfuryledine-1-cyclopentanone.

In the context of a further particularly preferred version of the present invention, R¹⁷ is hydrogen.

R¹⁸ and R¹⁹ in this connection are each independently with advantage hydrogen, C₁-C₂₀-alkyl, carboxyaldehyde, hydroxyalkyl, carboxyl, amino, nitro, alkylamino, aminoalkyl, alkyloxyalkyl, alkylaminoalkyl, alkylcarboxy, alkenylcarboxy, furyl, furylalkyl, hydroxyalkylfurylalkyl, alkyloxy, alkenyloxy, alkylcarbonylalkenyl, oxiranyl, alkenylcarbonyl, alkylcarbonyloxyalkyl, alkyloxycarbonylalkenyl, alkenylcarbonyloxyalkyl, isocyanate, isocyanatoalkyl, alkylcarbonyl, halocarbonyl, haloalkyl, haloaryl, haloalkenyl, imino, thioalkyl, alkylthioalkyl and/or cyano, with preference hydrogen, C₁-C₂₀-alkyl, carboxyaldehyde, hydroxyalkyl, carboxyl, alkylamino, aminoalkyl, alkylaminoalkyl, alkyloxy, alkyloxyalkyl, furylalkyl, hydroxyalkylfurylalkyl, alkenyloxy, alkylcarbonylalkenyl, alkenylcarbonyl, alkylcarbonaloxyalkyl, alkyloxycarbonylalkenyl, alkenylcarbonyloxyalkyl, alkylcarboxy, alkenylcarboxy and/or alkylcarbonyl, with particular preference hydrogen, C₁-C₁₀-alkyl, carboxyaldehyde, hydroxyalkyl, alkylamino, aminoalkyl, alkylaminoalkyl, alkyloxy, alkyloxyalkyl, furylalkyl, hydroxyalkylfurylalkyl, carboxyl, alkenyloxy, alkylcarboxy, alkenylcarboxy, alkylcarbonyl, and/or alkylenecarbonyl, especially hydrogen, C₁-C₁₀-alkyl, carboxyaldehyde, hydroxyalkyl, aminoalkyl, alkylaminoalkyl, alkyloxyalkyl, furylalkyl, hydroxyalkylfurylalkyl and/or carboxyl, wherein each group may be substituted with C₁-C₂₀-alkyl, C₂-C₂₀-alkenyl, C₂-C₂₀-alkynyl, C₅-C₂₄-aryl, hydroxyl, carboxyl, nitro, amino, furyl, furylalkyl, alkylfuryl, hydroxyalkylfurylalkyl, isocyanate, formyl, halocarbonyl, thiol and/or alkylthio. It is very particularly preferable for R¹⁸ and R¹⁹ to each be independently hydrogen, C₁-C₂ alkyl, carboxaldehyde, hydroxyalkyl, carboxyl, aminoalkyl, alkylaminoalkyl, hydroxyalkylfurylalkyl, alkoxyalkyl, oxiranyl and/or isocyanate, especially hydrogen.

R²⁰ in this connection is with advantage hydrogen, C₁-C₂₀-alkyl, carboxyaldehyde, hydroxyalkyl, carboxyl, amino, nitro, alkylamino, aminoalkyl, alkyloxyalkyl, alkylaminoalkyl, alkylcarboxy, alkenylcarboxy, furyl, furylalkyl, hydroxyalkylfurylalkyl, alkyloxy, alkenyloxy, alkylcarbonylalkenyl, oxiranyl, alkenylcarbonyl, alkylcarbonyloxyalkyl, alkyloxycarbonylalkenyl, alkenylcarbonyloxyalkyl, isocyanate, isocyanatoalkyl, alkylcarbonyl, halocarbonyl, haloalkyl, haloaryl, haloalkenyl, imino, thioalkyl, alkylthioalkyl and/or cyano, with preference hydrogen, C₁-C₂₀-alkyl, carboxyaldehyde, hydroxyalkyl, carboxyl, alkylamino, aminoalkyl, alkylaminoalkyl, alkyloxy, alkyloxyalkyl, furylalkyl, hydroxyalkylfurylalkyl, alkenyloxy, alkylcarbonylalkenyl, alkenylcarbonyl, alkylcarbonaloxyalkyl, alkyloxycarbonylalkenyl, alkenylcarbonyloxyalkyl, alkylcarboxy, alkenylcarboxy and/or alkylcarbonyl, with particular preference hydrogen, C₁-C₁₀-alkyl, carboxyaldehyde, hydroxyalkyl, alkylamino, aminoalkyl, alkylaminoalkyl, alkyloxy, alkyloxyalkyl, furylalkyl, hydroxyalkylfurylalkyl, carboxyl, alkenyloxy, alkylcarboxy, alkenylcarboxy, alkylcarbonyl, and/or alkylenecarbonyl, especially hydrogen, C₁-C₁₀-alkyl, carboxyaldehyde, hydroxyalkyl, aminoalkyl, alkylaminoalkyl, alkyloxyalkyl, furylalkyl, hydroxyalkylfurylalkyl and/or carboxyl, wherein each group may be substituted with C₁-C₂₀-alkyl, C₂-C₂₀-alkenyl, C₂-C₂₀-alkynyl, C₅-C₂₄-aryl, hydroxyl, carboxyl, nitro, amino, furyl, furylalkyl, alkylfuryl, hydroxyalkylfurylalkyl, isocyanate, formyl, halocarbonyl, thiol and/or alkylthio. With very particular preference R²⁰ is C₁-C₂ alkyl, carboxaldehyde, hydroxyalkyl, carboxyl, aminoalkyl, alkylaminoalkyl, hydroxyalkylfurylalkyl, alkoxyalkyl, oxiranyl or isocyanate, especially hydroxyalkyl, particularly CH₂OH.

The broken line in this connection preferably depicts a double bond.

In the context of a particularly preferred embodiment of the present invention, the polymerizable composition, based on the overall weight of the polymerizable components, contains not less than 50.0 wt %, preferably not less than 60.0 wt %, more preferably not less than 75.0 wt %, even more preferably not less than 90.0 wt %, yet even more preferably not less than 95.0 wt % and especially 100.0 wt % of furfuryl alcohol, which is advantageously obtained from agricultural products, especially from bagasse, maize straw or other agricultural raw materials.

Preferred comonomers in this connection include compounds of formula (I) or (II) wherein R¹⁷ is not hydrogen, especially the abovementioned compounds. Further preferred comonomers include furfural, formaldehyde, ketones and also phenols.

The proportion of the overall weight of the polymerizable components which is contributed by the comonomers, however, is preferably not more than 50.0 wt %, advantageously not more than 40.0 wt %, more preferably not more than 25.0 wt %, even more preferably not more than 10.0 wt % and yet even more preferably not more than 5.0 wt %. In the context of a particularly preferred embodiment of the present invention, the polymerizable composition does not include any comonomers in that it contains furfuryl alcohol only.

The amounts of compounds of formula and compounds of formula (I) and/or (II) are freely choosable in principle. Preferably, however, the polymerizable composition, based on its overall weight, comprises
more than 70.0 wt %, preferably more than 80.0 wt % and especially more than 90.0 wt % of one or more compounds of formula (II),
0 to 30.0 wt %, preferably from 0 to 20.0 wt % and especially from 0 to 10.0 wt % of one or more compounds of formula (I),
optionally 0 to 40.0 wt % and preferably from 0 to 30.0 wt % of condensation products thereof.

In a particularly preferred embodiment of the present invention, the polymerizable composition, in terms of its overall weight, includes
up to 70.0 wt %, preferably up to 55.0 wt % and especially up to 25.0 wt % of 2,5-bis(hydroxymethyl)furan (BHMF),
up to 20.0 wt %, preferably up to 15.0 wt % and especially up to 5.0 wt % of -2,3,5-tris(hydroxymethyl)furan (THMF),
up to 10.0 wt %, preferably up to 5.0 wt % and especially up to 1.0 wt % of 2,2′-hydroxymethyldifurylmethane (HMDM).

The composition may further optionally contain up to 40.0 wt % and preferably up to 30.0 wt % of condensation products of BHMF, THMF and/or HMDM.

In a further preferred embodiment of the present invention, the polymerizable composition in terms of its overall weight includes
up to 60.0 wt % and preferably up to 30.0 wt % of a compound of formula (I) and/or (II), where n is not more than 5, and
up to 40.0 wt % and preferably up to 60.0 wt % of condensation products thereof.

In the context of the present invention, the polymerizable composition preferably comprises disubstituted, trisubstituted or polysubstituted furan compounds or a mixture thereof. It may further contain a solvent, a catalyst (initiator), coupling agents, fillers, flame retardants, oil (wax) and/or a surfactant.

In a preferred embodiment of the present invention, the compounds of the present composition are diluted in a solvent. The concentration of the compounds in the solvent is preferably between 5.0 and 95.0 wt % and more preferably between 10.0 wt % and 80.0 wt %, based on the overall weight of the solution. Examples of preferred solvents include water, alcohols, especially ethanol and methanol, dioxane, N,N-dimethylformamide, acetone, ethylene glycol and glycerol.

In a particularly preferred embodiment of the present invention, the solvent is water. The furan compounds of the present invention are preferably soluble in water. In a further preferred embodiment, the furan compounds of the present invention are soluble in water in the presence of a catalyst. The expression “water soluble” as used herein refers to the amount which is soluble in water at room temperature after standing for 48 h on adding 5.0 g of furan compounds to 95.0 g of deionized water. The percentage water solubility can be calculated by the formula:

water solubility=100×(5.0 g of furan compounds−weight of water-insoluble remainder)/(5.0 g of furan compounds).

In the present invention, the furan compounds can be reacted in the presence or absence of catalysts. The polymerizable composition can therefore contain a catalyst. Preferred catalysts include metal salts, ammonium salts, organic acids, anhydrides, inorganic acids and also mixtures thereof. Preferred metal salts include metal halides, especially magnesium chloride, aluminum chloride and zinc chloride, metal sulfates, especially magnesium sulfate and aluminum sulfate, metal nitrates, especially magnesium nitrate, aluminum nitrate and zinc nitrate, metal phosphates and also mixtures thereof. Preferred ammonium salts include ammonium chloride, ammonium sulfate, ammonium phosphate, ammonium carbonate, ammonium bicarbonate, ammonium oxalate, ammonium citrate, ammonium nitrate, ammonium fumarate, ammonium levulinate and also mixtures thereof. Preferred organic or inorganic acids include formic acid, acetic acid, propionic acid, butyric acid, pentanoic acid, hexanoic acid, oxalic acid, maleic acid, maleic anhydride, adipic acid, citric acid, furoic acid, benzoic acid, phthalic anhydride, para-toluenesulfonic acid, hydrochloric acid, sulfuric acid, nitric acid, phosphoric acid, boric acid, silicic acid, benzoyl peroxide and also mixtures thereof.

Depending on the catalyst and the curing temperature and the desired properties, the composition preferably includes up to 20 wt % (or more), more preferably in the range from 1.0 wt % to 15.0 wt %, even more preferably in the range from 8.0 wt % to 10.0 wt %, yet even more preferably in the range from 5.0 wt % to 8.0 wt % and especially 5.0 wt % of catalyst, all based on the overall amount of the (dried) furan compounds in the composition.

In a further preferred embodiment of the present invention, the furan compounds, especially 2,5-bis(hydroxymethyl)furan (BHMF), 2,3,5-tris(hydroxymethyl)furan (THMF), 2,2′-(hydroxymethyl)difurylmethane (HMDM), condensation products thereof, 2,2′,3,3′-(hydroxymethyl)difurylmethane, 2,2′,4,4′-(hydroxymethyl)difurylmethane, are obtained by hydroxymethylation of furfuryl alcohol with a formaldehyde source, especially with formaldehyde, paraformaldehyde or trioxane.

The furan resin is preferably formed under acid catalysis, in accordance with the general reaction equation

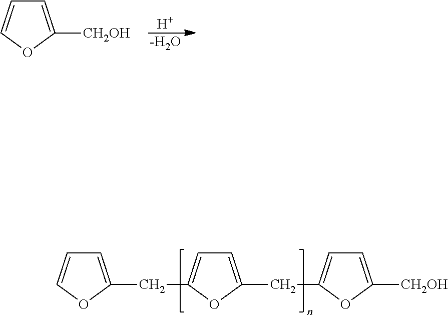

where only the polycondensation of furfuryl alcohol was depicted and any comonomers were disregarded for clarity.

The furan resin is preferably crosslinked primarily by condensation of a terminal methylol group in an oligomer or polymer with a methylene group of another chain; preferably again under acid catalysis:

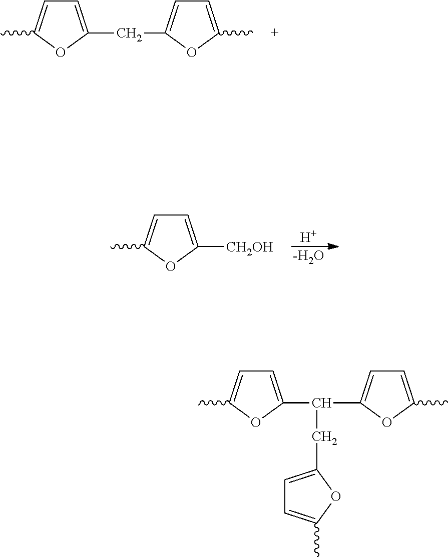

Again, any comonomers or substituents are not depicted for clarity.

Crosslinking is also possible via an addition of a terminal methylol group in an oligomer or polymer onto a double bond of another chain, but this is less preferable in the context of the present invention.

Suitable acids for catalyzing the polymerization and/or crosslinking include organic and inorganic acids, especially organic acids. Strong acids, especially toluenesulfonic acid, xylenesulfonic acid, benzenesulfonic acid, hydrochloric acid and sulfuric acid, are particularly preferable in this connection. A mixture of toluenesulfonic acid and benzenesulfonic acid will be found to be very particularly advantageous.

A further preferred embodiment of the present invention utilizes a weak acid (especially phosphoric acid) which preferably causes a longer pot life and preferably requires the resin to be cured at a temperature in the range from 100° C. to 200° C.

The amount of the acid is in principle freely choosable in this connection. It is preferably in the range from 1.0 to 45.0 wt %, more preferably in the range from 10.0 wt % to 40.0 wt % and especially in the range from 15.0 wt % to 35.0 wt %, all based on the overall weight of furan resin monomers and oligomers as well as acid catalyst.

Particularly suitable furan resins in the context of the present invention have a differential scanning calorimetry (DSC) diagram peak in the range from 120° C. to 160° C., preferably in the range from 130° C. to 145° C. and especially in the range from 131° C. to 139° C. The DSC measurement is preferably done at a heating rate of 5° C./minute.

For further details regarding furan resins and their preparation, reference is made to the technical literature, especially to Römpp-Lexikon Chemie; editors: Jürgen Falbe, Manfred Regitz; revised by Eckard Amelingmeier; Stuttgart, N.Y.; Thieme; 10^{th} edition—1997; volume 2 Cm-G, headword “Furan-Harze” and also Ullmann's Encyclopedia of Industrial Chemistry, Fifth Edition on CD-ROM, 1997, headword “Furan and derivatives—Furfurylalcohol” and the references cited therein.

The residual moisture content of the biocomposite plate according to the present invention is below 8.0 wt %, preferably below 7.0 wt %, more preferably below 6.0 wt % and especially below 5.0 wt % all based on its overall weight. The residual moisture content is preferably determined in line with the EN 20287 standard after 24 h drying in a drying cabinet at 105° C. and more preferably after 48 h drying in a drying cabinet at 105° C.

The weight fraction of the biopolymer, based on the overall weight of the biocomposite plate, in the context of the present invention is not less than 20.0 wt % and is advantageously in the range from 20.0 wt % to 45.0 wt %, preferably in the range from 25.0 wt % to 40.0 wt %, more preferably in the range from 28.0 wt % to 36.0 wt % and even more preferably in the range from 30.0 wt % to 34.0 wt %.

The weight ratio of natural fibers to biopolymer in the present invention is preferably in the range from 5:1 to 1:5 and especially in the range from 4:1 to 1:1.

The biocomposite plate of the present invention is obtainable in a conventional manner.

The biocomposite plate of the present invention is preferably obtained by preparing a construction that contains the paper sheets, preferably recycled paper sheets, optionally the decor paper sheet, preferably a recycled paper sheet, and a suitable binder system, and preferably this construction being introduced between special platens and compressed, curing the binder system in the process.

In a procedure which will be found particularly advantageous,

a) two or more sheets of paper are impregnated with a composition comprising one or more than one compound of formula (I) and/or formula (II) or a prepolymer thereof,

b) the sheets from step a. are superposed and pressed together flat under elevated temperature and pressure,

wherein the polymerizable composition preferably undergoes polymerization and/or crosslinking in step b.

Although the present description refers to “the” decor paper sheet, a person skilled in the art will appreciate that, depending on the constitution desired for the biocomposite plate, two or more decor paper sheets can also be used.

To prepare the construction, individual sheets, preferably all the sheets, of the various layers are preferably impregnated with a suitable binder.

In a preferred embodiment, the construction comprises a plurality of sheets of paper, preferably two to 200 sheets of paper, especially sheets of kraft paper. A decor paper sheet is preferably disposed on the uppermost sheet of paper.

In a further preferred embodiment, the decor paper sheet applied atop the uppermost sheet of paper is a prepreg comprising decor paper and a suitable binder.

In a further preferred embodiment, the sheets of paper in the construction are preferably impregnated with a composition which, based on the overall weight of the polymerizable components, contains not less than 50.0 wt % of at least one compound of formula (I) and/or formula (II), especially furfuryl alcohol, and/or furan resin prepolymers based on compounds of formula (I) and/or formula (II), especially furfuryl alcohol, and also preferably at least one acidic catalyst. What is concerned is preferably a thermosetting resin, the curing temperature of which is preferably in the range from 70° C. to 200° C., advantageously in the range from 100° C. to 180° C. and especially in the range from 140° C. to 160° C.

The decor paper sheet optionally present in the construction is preferably likewise impregnated with a composition which, based on the overall weight of the polymerizable components, contains not less than 50.0 wt % of at least one compound of formula (I) and/or formula (II), especially furfuryl alcohol, and/or furan resin prepolymers based on compounds of formula (I) and/or formula (II), especially furfuryl alcohol, and also preferably at least one acidic catalyst. What is concerned is preferably a thermosetting resin, the curing temperature of which is preferably in the range from 70° C. to 200° C., advantageously in the range from 100° C. to 180° C. and especially in the range from 140° C. to 160° C.

The binder content of the impregnated sheet of decor depends inter alia on the motif of the decor sheet. In the case of solid-colored decors, the binder content of the impregnated sheet of decor is preferably in the range from 35.0 wt % to 65.0 wt %, more preferably in the range from 42.0 wt % to 60.0 wt % and even more preferably in the range from 48.0 wt % to 55.0 wt %. In the case of multicolored, pattern-produced or otherwise printed decor motifs, the binder content of the impregnated sheet of decor is preferably in the range from 35.0 wt % to 65.0 wt %, more preferably in the range from 37.0 wt % to 50.0 wt % and even more preferably in the range from 40.0 wt % to 45.0 wt %.

A construction prepared according to the present invention is then preferably introduced between two platens, which are preferably matte, smooth or textured, and compressed.

The compression-molding conditions for the construction are preferably a temperature in the range from 70° C. to 200° C., more preferably in the range from 120° C. to 160° C. and especially from 130° C. to 160° C., and preferably an elevated pressure of preferably not less than 4 N/mm², preferably not less than 5 N/mm² and more preferably not less than 7 N/mm². Molding time is preferably in the range from 40 minutes to 90 minutes and more preferably in the range from 50 minutes to 80 minutes.

The simultaneous application of heat and high pressure causes the binders to flow and then cure.

The product obtained after the construction has been compression-molded and the resins cured is finally referred to as biocomposite plate.

The ready-produced biocomposite plate has different thicknesses, depending on the choice of construction. Typical thicknesses range from 0.5 mm to 2 mm, preferably from 0.6 mm to 1.5 mm and more preferably from 0.8 mm to 1.2 mm. However, it is also possible to produce biocomposite plates having much greater thicknesses, for example in the range from 2 mm to 40 mm, preferably in the range from 2 mm to 30 mm and more preferably in the range from 2 mm to 20 mm.

The thickness of the decor layer, if present, is preferably in the range from 65 μm to 200 μm and more preferably in the range from 80 μm to 150 μm. The thickness of the core layer in a first preferred embodiment of the present invention is in the range from 250 μm to 1900 μm and more preferably in the range from 500 μm to 1500 μm. In the context of a further preferred embodiment of the present invention, the thickness of the core layer is in the range from 1.7 mm to 39.7 mm, preferably in the range from 1.7 mm to 29.7 mm and more preferably in the range from 1.7 mm to 19.7 mm.

The final weight of the biocomposite plate according to the present invention is dependent on several factors, for example the thickness of the biocomposite plate, the weight of the components used and the number of sheets used. In a first preferred embodiment of the present invention, the weight of the biocomposite plate is in the range from 1.0 kg/m² to 1.6 kg/m² of surface area of the biocomposite plate, more preferably in the range from 1.3 kg/m² to 1.5 kg/m², for example equal to 1.4 kg/m². In a further preferred embodiment of the present invention, the weight of the biocomposite plate is in the range from 2.8 kg/m² to 56.0 kg/m² of surface area of the biocomposite plate, more preferably in the range from 2.8 kg/m² to 42 kg/m² and especially in the range from 2.8 kg/m² to 28 kg/m².

The biocomposite plate of the present invention has outstanding properties and so is used particularly for wallcoverings, worktops, shop fittings, shelves, counter tops and/or furniture. Its use for floor coverings is also advantageous.

Accordingly, in a further aspect, the invention relates to a panel comprising a support and a biocomposite plate according to the present invention and adhered to the support. Preferably, the panel is a wallcovering. However, the panel can also be some other type of board, for example a tabletop board or a furniture board.

Preferred supports are chipboard, plywood, supporting panels (optionally coated with laminate), high density fiberboard, medium density fiberboard, hard fiberboard, joinery board, veneer board, solid wood, honeycombs, foamed plastics, metal plates, metal sheets, mineral supports, natural and artificial stone, tiles and gypsumboard. The supports may be coated with a suitable binder, or be uncoated. Preferably, however, biopolymers are used again as binders.

The biocomposite plate can be applied not only to liquid-imbibing (absorbent) supports, for example uncoated chipboard and uncoated wood, but also to non-liquid-imbibing (nonabsorbent) supports, for example metals, ceramics, glass, coated woods, coated chipboard, etc.

Processes and means for firmly connecting the biocomposite plate and the support are known from the prior art. For example, the biocomposite plate and the support can be firmly connected by adhering, or by means of connection elements known from the prior art.

The panel may further comprise functional materials known from the prior art. Examples are materials for flame retardancy, for shielding against radiation, for soundproofing, for stabilization and for moistureproofing.

The thickness of the panel is not further restricted. It preferably is in the range from 7 mm to 40 mm, more preferably in the range from 12 mm to 30 mm and even more preferably in the range from 18 mm to 28 mm. The thickness of the biocomposite plate in the panel, as mentioned above, may preferably be in the range from 0.5 mm to 2 mm, more preferably in the range from 0.6 mm to 1.5 mm and even more preferably in the range from 0.8 mm to 1.2 mm. The thickness of the support is preferably in the range from 5 mm to 38 mm, more preferably in the range from 10 mm to 28 mm and even more preferably in the range from 16 mm to 25 mm.

The final weight of the panel is not particularly restricted. It is preferably in the range from 8 kg/m² to 25 kg/m² of surface area of the panel, more preferably in the range from 10 kg/m² to 21 kg/m² and even more preferably in the range from 12 kg/m² to 18 kg/m².

Embodiments of the present invention, which are not to be construed as restrictive, will now be more particularly described by way of example:

### EXAMPLE 1

A recycled paper consisting of kraft-process chemical-pulp stuff and having a basis weight of nominally 210 g/m² was drenched with 52% of an approximately 60-65% strength furfuryl alcohol polymer solution (=furan resin) (including curing, wetting and release agents). Excess resin was removed at the surface between two polished steel drums. The impregnated paper was dried at room temperature for 2 h and then at 130° C. in a circulating air drying cabinet for 2 minutes to obtain a preimpregnated recycled paper.

### Producing an Inventive Biocomposite Plate

To produce an inventive biocomposite plate, the first step was to produce a suitable construction for pressing with two platens. To this end, 10 sheets of recycled paper which had been impregnated with the furan resin were assembled. A release sheet was placed in each case on the uppermost sheet of paper. A construction of this type is depicted in scheme 1.

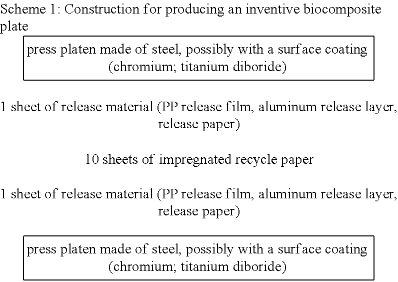

The construction thus prepared was compression-molded between two press platens as texturizers at a pressure of 10 N/mm² and a maximum temperature of 145° C. for 25 min and then cooled down to room temperature.

### EXAMPLE 2

The preimpregnated recycled paper produced in Example 1 was used to produce an inventive biocomposite plate except that now 23 sheets of recycled paper which had been impregnated with the furan resin were compression-molded together.

### EXAMPLE 3

The preimpregnated recycled paper produced in Example 1 was used to produce an inventive biocomposite plate except that now 28 sheets of recycled paper which had been impregnated with the furan resin were compression-molded together.

### EXAMPLE 4

The preimpregnated recycled paper produced in Example 1 was used to produce an inventive biocomposite plate except that now 48 sheets of recycled paper which had been impregnated with the furan resin were compression-molded together.

### Results

The biocomposite plates obtained in the exemplary embodiments were strength tested. Density was determined to EN ISO 1183-1. Mechanical strengths were determined in accordance with EN ISO 178 in a three-point bending test. The values obtained are depicted in Table 1:

TABLE 1
Test results

| | Plate | Bending strength | Elastic modulus | |
|---|---|---|---|---|
| Exam- | thickness | in N/mm² | in N/mm² | Density |
| ple | in mm | along/across | along/across | in g/cm³ |
| 1 | 2.22 | 182.2/126.5 | 15424/9346 | 1.46 |
| 2 | 4.84 | 145.8/116.8 | 13272/9683 | 1.45 |
| 3 | 5.90 | 147.4/122.7 | 10491/7581 | 1.46 |
| 4 | 10.37 | 178.3/146.0 | 11666/7895 | 1.46 |

1. A biocomposite plate, comprising:
at least one natural fiber and
at least one thermoset biopolymer,
wherein
the biocomposite plate has a residual moisture content, based on its overall weight, below 8.0 wt %,
the biocomposite plate comprises at least two sheets of paper,
the biopolymer includes a furan resin obtained by polymerizing a composition containing a compound of formula (I) and/or formula (II) 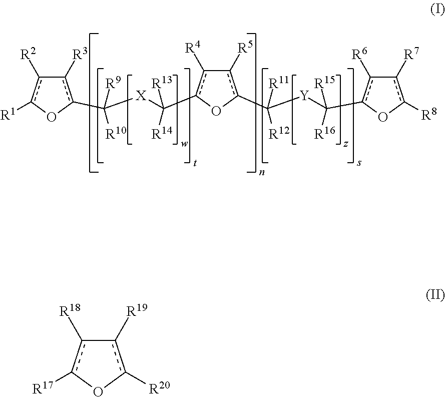
where
n is an integer between 0 and 20,
t and s are each independently an integer between 1 and 20,
w and z are each independently 0 or 1,
X and Y are each independently O, S, or N—R²¹,
R¹, R², R³, R⁴, R⁵, R⁶, R⁷, R⁸, R⁹, R¹⁰, R¹¹, R¹², R¹³, R¹⁴, R¹⁵, R¹⁶, R¹⁸, R¹⁹, and R²¹ are each independently hydrogen, C₁-C₂₀-alkyl, C₂-C₂₀-alkenyl, C₂-C₂₀-alkynyl, C₅-C₂₄-aryl, C₅-C₁₂-heteroaryl, carboxyaldehyde, hydroxyl, hydroxyalkyl, carboxyl, amino, nitro, formyl, alkylamino, aminoalkyl, alkylaminoalkyl, furyl, furylalkyl, hydroxyalkylfurylalkyl, alkyloxy, alkyloxyalkyl, alkenyloxy, alkylcarbonylalkenyl, oxiranyl, alkylcarbonaloxyalkyl, alkyloxycarbonylalkenyl, alkenylcarbonyloxyalkyl, isocyanate, isocyanatoalkyl, alkylcarboxy, alkenylcarboxy, alkylcarbonyl, alkenylcarbonyl, halocarbonyl, haloalkyl, haloaryl, haloalkenyl, imino, thiol, alkylthio, thioalkyl, alkylthioalkyl, cyano, alkylsulfonyl, and/or a sulfonic acid group, wherein every group can be substituted with C₁-C₂₀-alkyl, C₂-C₂₀-alkenyl, C₂-C₂₀-alkynyl, C₅-C₂₄-aryl, hydroxyl, carboxyl, nitro, amino, furyl, furylalkyl, alkylfuryl, hydroxyalkylfurylalkyl, isocyanate, formyl, halocarbonyl, thiol, and/or alkylthio,
R¹⁷ is hydrogen, C₁-C₂₀-alkyl, C₂-C₂₀-alkenyl, C₂-C₂₀-alkynyl, C₅-C₂₄-aryl, C₅-C₁₂-heteroaryl, carboxyaldehyde, hydroxyl, hydroxyalkyl, carboxyl, amino, nitro, formyl, alkylamino, aminoalkyl, alkylaminoalkyl, furyl, furylalkyl, hydroxyalkylfurylalkyl, alkyloxy, alkyloxyalkyl, alkenyloxy, alkylcarbonylalkenyl, oxiranyl, alkylcarbonyloxyalkyl, alkyloxycarbonylalkenyl, alkenylcarbonyloxyalkyl, isocyanate, isocyanatoalkyl, alkylcarboxy, alkenylcarboxy, alkylcarbonyl, alkenylcarbonyl, halocarbonyl, haloalkyl, haloaryl, haloalkenyl, imino, thiol, alkylthio, thioalkyl, alkylthioalkyl, cyano, alkylsulfonyl, and/or a sulfonic acid group, wherein every group can be substituted with C₁-C₂₀-alkyl, C₂-C₂₀-alkenyl, C₂-C₂₀-alkynyl, C₅-C₂₄-aryl, hydroxyl, carboxyl, nitro, amino, furyl, furylalkyl, alkylfuryl, hydroxyalkylfurylalkyl, isocyanate, formyl, halocarbonyl, thiol, and/or alkylthio,
R²⁰ is C₁-C₂₀-alkyl, C₂-C₂₀-alkenyl, C₂-C₂₀-alkynyl, C₅-C₂₄-aryl, C₅-C₁₂-heteroaryl, carboxyaldehyde, hydroxyl, hydroxyalkyl, carboxyl, amino, nitro, formyl, alkylamino, aminoalkyl, alkylaminoalkyl, furyl, furylalkyl, hydroxyalkylfurylalkyl, alkyloxy, alkyloxyalkyl, alkenyloxy, alkylcarbonylalkenyl, oxiranyl, alkylcarbonyloxyalkyl, alkyloxycarbonylalkenyl, alkenylcarbonyloxyalkyl, isocyanate, isocyanatoalkyl, alkylcarboxy, alkenylcarboxy, alkylcarbonyl, alkenylcarbonyl, halocarbonyl, haloalkyl, haloaryl, haloalkenyl, imino, thiol, alkylthio, thioalkyl, alkylthioalkyl, cyano, alkylsulfonyl, and/or a sulfonic acid group, wherein every group can be substituted with C₁-C₂₀-alkyl, C₂-C₂₀-alkenyl, C₂-C₂₀-alkynyl, C₅-C₂₄-aryl, hydroxyl, carboxyl, nitro, amino, furyl, furylalkyl, alkylfuryl, hydroxyalkylfurylalkyl, isocyanate, formyl, halocarbonyl, thiol, and/or alkylthio, and
wherein the broken line optionally depicts an optional a double bond, and
the weight fraction of the biopolymer, based on the overall weight of the biocomposite plate, is not less than 20.0 wt %.

2. The biocomposite plate as claimed in claim 1, wherein the biocomposite plate has a residual moisture content, based on its overall weight, below 5.0 wt %.

3. The biocomposite plate as claimed in claim 1, wherein the natural fiber, based on its overall weight, comprises more than 50.0 wt % of cellulose fibers.

4. The biocomposite plate as claimed in claim 1, wherein R¹⁷ is hydrogen.

5. The biocomposite plate as claimed in claim 1, wherein R²⁰ is C₁-C₂ alkyl, carboxaldehyde, hydroxyalkyl, carboxyl, aminoalkyl, alkylaminoalkyl, hydroxyalkylfurylalkyl, alkoxyalkyl, oxiranyl, or isocyanate, and the broken line depicts a double bond.

6. The biocomposite plate as claimed in claim 1, wherein the polymerizable composition, based on the overall weight of the polymerizable components, contains not less than 50.0 wt % of furfuryl alcohol.

7. The biocomposite plate as claimed in claim 1, wherein the polymerizable composition, based on its overall weight, comprises
more than 70.0 wt % of one or more compounds of formula (II),
0 to 30.0 wt % of one or more compounds of formula (I), and
optionally 0 to 40.0 wt % of condensation products thereof.

8. The biocomposite plate as claimed in claim 1, wherein the weight fraction of the biopolymer, based on the overall weight of the biocomposite plate, is in the range from 20.0 wt % to 45.0 wt %.

9. The biocomposite plate as claimed in claim 1, wherein the weight ratio of natural fibers to biopolymer is in the range from 5:1 to 1:5.

10. A process for producing a biocomposite plate claimed in claim 1, comprising:
a) impregnating two or more sheets of paper with a composition comprising one or more than one compound of formula (I) and/or formula (II) or a prepolymer thereof, and
b) superposing the sheets from step a) and pressing the sheets from a) together flat under elevated temperature and pressure.

11. The process as claimed in claim 10, comprising polymerizing and/or crosslinking the compound of formula (I) or of formula (II) in step b).

12. The process as claimed in claim 10, wherein the sheets of paper have a raw paper basis weight ranging from 150 g/m² to 250 g/m².

13. The process as claimed in claim 10, comprising using recycled sheets of paper.

14. A biocomposite plate as claimed in claim 1 comprising a wallcovering, a worktop, a shop fitting, a shelf, a counter top, furniture, or a floorcovering.

15. A panel comprising a support and a biocomposite plate as claimed in claim 1 adhered to the support.

16. The biocomposite plate as claimed in claim 5, wherein R²⁰ is hydroxyalkyl.

17. The biocomposite plate as claimed in claim 16, wherein R²⁰ is CH₂OH.
